(19) United States
(12) Patent Application Publication
(10) Pub. No.: US 2009/0104389 A1
(43) Pub. Date: Apr. 23, 2009

(54) Polymer Article Modified with a Metal Cation Containing Compound

(76) Inventors: Stefano Gardi, Bologna (IT); Massimiliano Sala, Castelnuovo Ranone (MO) (IT); Gunther Schlingloff, Riehen (CH)

Correspondence Address: JoAnn Villamizar;Patent Department, 540 White Plains Road, P O Box 2005, Tarrytown, NY, 10591-9005, US

(21) Appl. No.: 12/227,081

(22) PCT Filed: May 9, 2007
(86) PCT No.: PCT/EP2007/054462

§ 371 Date: Nov. 6, 2008

(30) Foreign Application Priority Data
May 11, 2006 (EP) 06113810.3

(51) Int. Cl. B32B 1/08; C08J 3/22; C08L 33/02; C08F 20/06; B32B 1/00; B32B 27/32

(52) U.S. Cl. 428/35.2; 523/351; 525/201; 428/36.9; 524/176; 526/241

(57) ABSTRACT

An agricultural article made of a composition containing (a) an organic polymer, and (b-I) a polyacrylic acid sodium salt or a sodium salt of ethylene/methacrylic acid copolymer, and (b-II) manganese stearate.

The present invention relates in particular to an agricultural article made of a composition containing (a) an organic polymer and (b) particular organic metal salts; to the use of the organic metal salts for controlling the weathering resistance and the degradation of the agricultural article; as well as to several novel polymeric organic metal salts.

Plastic articles find widespread applications in everyday life because of their durability in use and cost effectiveness. With proper stabilization, most commercial plastics are made to last for years.

In recent years however, environmental concern has lead to the development of so called biodegradable materials, of diverse origin and nature, which will maintain their function and integrity during service life, but disintegrate after use into carbon dioxide and water, either triggered by chemical means or by microorganisms. One problem however is establishing a suitable equilibrium between biodegradability and integrity during service life.

Compostable thermoplastic compositions are described in e.g. U.S. Pat. No. 5,258,422.

Degradable synthetic polymeric compounds are disclosed in e.g. U.S. Pat. No. 5,352,716.

High acid ionomers and golf ball cover compositions comprising same are described in e.g. U.S. Pat. No. 6,277,921. The article of the present invention is different from a golf ball or golf ball cover.

Photodegradable polyolefin compositions are described in e.g. JP-A-Sho 50-34,045.

Polyolefin compositions and degradable films made therefrom are disclosed in e.g. U.S. Pat. No. 3,454,510.

Degradable/compostable concentrates, process for making degradable/compostable packaging materials and the products thereof are described in e.g. U.S. Pat. No. 5,854,304.

Chemically degradable polyolefin films are disclosed in e.g. U.S. Pat. No. 5,565,503.

The present invention especially relates to

an agricultural article made of a composition containing
(a) an organic polymer, and
(b-I) 0.001 to 9% by weight, relative to the weight of the organic polymer of one, two or more compounds of the formula (I)

—(X)ₘ—(Y)ₙ— (I)

wherein
m is different from zero,
n is zero or different from zero,
m+n is 10 to 10×10⁶, and
when n is different from zero, the ratio of m/n is 1/100 to 100/1,
the recurring units X can have the same definition or different definitions,
the recurring units Y can have the same definition or different definitions and
the recurring units X and Y can have a random distribution or a block distribution;
X is a group of the formula (II-1) and Y is a group of the formula (II-2)

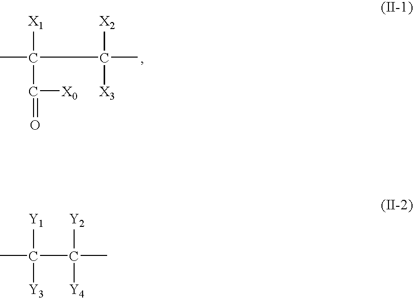

in which
X₁, X₂ and X₃ independently of one another are hydrogen, C₁-C₄alkyl or phenyl,
Y₁, Y₂ and Y₄ independently of one another are hydrogen, C₁-C₄alkyl or phenyl,
Y₃ is hydrogen, C₁-C₄alkyl, phenyl or a group —C(O)—Y₀,
X₀ is a group of the formula

—O⁻1/rM^{r+}, —O⁻N⁺(R₁)₄ or —N(R₃)₂,

and when n is zero, X₀ is additionally a group —OH or —OR₂,
Y₀ is a group of the formula

—OH or —O—R₂,

M is a metal cation of valency r with r being 1, 2, 3 or 4,
the radicals R₁ independently of one another are hydrogen, C₁-C₂₀alkyl, C₃-C₁₂cycloalkyl or phenyl,
R₂ is C₁-C₂₀alkyl or C₃-C₁₂cycloalkyl, and
the radicals R₃ independently of one another are hydrogen, C₁-C₂₀alkyl or C₃-C₁₂cycloalkyl; with the provisos that
1) component (b-I) is different from component (a);
2) when the compound of the formula (I) is either free of a transition metal cation or up to 1% of the recurring units X contain a transition metal cation, the composition contains as further component (b-II) one, two or more organic salts of a transition metal;
3) when in the compound of the formula (I) 1 to 100% of the recurring units X contain a transition metal cation, component (b-II) is optionally present in the composition;
4) component (b-II) is different from component (b-I); and
5) when, for n being different from zero, the metal cation of component (b-I) is selected from the group consisting of the cations of Co, Cu, Mn or Cr, the composition contains either two or more different transition metal cations or as further component a pigment and/or a light stabilizer.

The weight ratio of components (b-I)/(b-II) is preferably 10 000/1 to 1/50 000, more preferably 2 000/1 to 1/5 000 or 1/100 to 100/1 or 1/20 to 20/1.

The compounds of the formula (I) can be prepared according to known methods, for example in analogy to the methods described in the present examples. Several compounds of the formula (I) are commercially available.

The end groups which terminate the polymeric compounds of the formula (I) depend on the preparation; e.g. on the chain termination agents (capping agents) used during the polymerization process.

Suitable examples of capping agents are toluene, oxygen, mercaptanes such as 1-butanethiol, 1-dodecanethiol, phosphinic acid sodium salt, carbonotrithioic acid bis(phenylmethyl)ester and tetrabromomethane.

A suitable example of the end groups is hydrogen.

Examples of alkyl with up to 20 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethyl-butyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl and eicosyl.

Examples of C₃-C₁₂cycloalkyl are cyclopropyl, cyclobutyl, cyclopentyl, cyclohexyl, cycloheptyl, cyclooctyl and cyclododecyl.

The ratio m/n is preferably 1/100 to 28/72, more preferably 1/70 to 1/5, in particular 1/50 to 1/5 or 1/70 to 1/10 or 1/50 to 1/10.

m+n is preferably 10 to 82 000, more preferably 20 to 50 000, in particular 30 to 10 000; 30 to 8 000; 30 to 800; 30 to 100 or 30 to 80.

The m+n values are based on the average number molecular weight ( M̅n).

In the following the molecular weight, if not further specified, relates to the average ponderal molecular weight ( M̅w) which may be determined by e.g. GPC (Gel Permeation Chromatography), which is used as an analytical procedure for separating molecules by their difference in size and to obtain molecular weight averages ( M̅w, M̅n).

The technique is well known and described, for instance, in “Modern Size-Exclusion Liquid Chromatography” by W. W. Yan et al., edited by J. Wiley & Sons, N.Y., USA, 1979, pages 4-8, 249-283 and 315-340.

The GPC analyses may be carried out for example with a GPC chromatograph ®Perkin-Elmer LC 250 equipped with ®Perkin-Elmer RI detector LC 30 and with ®Perkin-Elmer oven LC 101 according to the recommendations of the manufacturer.

Preferred molecular weights of component b) are 300 to 3 000 000 g/mol, 300 to 1 000 000 g/mol, 1 000 to 1 000 000 g/mol or 2 000 to 1 000 000 g/mol, 1 000 to 500 000 g/mol, 2 000 to 500 000 g/mol or 5 000 to 500 000 g/mol.

M is preferably a cation selected from the group consisting of alkali metal cations, earth alkali metal cations and transition metal cations, in particular from the group consisting of the cations of Li, Na, K, Ca, Mg, Mn, Fe, Co, Ni, Zn and Ce.

According to a preferred embodiment of the present invention, 5 to 50%, in particular 5 to 20%, of the recurring units X contain a metal cation.

According to another embodiment of the present invention, 50 to 100%, for example 70 to 100% or 80 to 100%, of the recurring units X contain a metal cation.

Compounds of the formula (I), wherein X₀ is a group of the formula —O⁻1/rM^{r+}, —O⁻N⁺(R₁)₄ or —N(R₃)₂, are preferred.

One radical of the radicals X₁, X₂ and X₃ is preferably different from hydrogen.

X₁, X₂ and X₃ are more preferably hydrogen.

Y₁, Y₂ and Y₄ independently of one another are preferably hydrogen or C₁-C₄alkyl; and Y₃ is preferably hydrogen, C₁-C₄alkyl, phenyl or —COOH.

The compound of the formula (I) is preferably a metal salt of

polyacrylic acid;
C₁-C₄alkyl acrylate/acrylic acid copolymer, in particular methyl acrylate/acrylic acid copolymer, ethyl acrylate/acrylic acid copolymer, propyl acrylate/acrylic acid copolymer, butyl acrylate/acrylic acid copolymer;
polymethacrylate;
C₁-C₄alkyl methacrylate/methacrylic acid copolymer, in particular methyl methacrylate/methacrylic acid copolymer, ethyl methacrylate/methacrylic acid copolymer, propyl methacrylate/methacrylic acid copolymer, butyl methacrylate/methacrylic acid copolymer;
acrylic acid/methacrylic acid copolymer;
ethylene/acrylic acid copolymer;
ethylene/methacrylic acid copolymer;
ethylene/C₁-C₄alkyl acrylate/acrylic acid copolymer; or
ethylene/C₁-C₄alkyl methacrylate/methacrylic acid copolymer.

Further examples of component (b-I) are

polyacrylic acid, polymethacrylic acid and acrylic acid/methacrylic acid copolymer.

The polymers and copolymers, which are used to prepare the metal salts of the present invention, preferably have a molecular weight of 300 to 3 000 000 g/mol; 300 to 1 000 000 g/mol, 2 000 to 1 000 000 g/mol or 5 000 to 500 000 g/mol.

The metal salts of the above indicated polymers can also be partial metal salts that means a considerable amount of —COOH groups may still be present in the compounds; for example 10 to 99%, preferably 10 to 90%; 20 to 80%; 30 to 99%; 30 to 90%; 30 to 50%; in particular 20 to 40% of the original —COOH groups of the polymer may be in the form of a metal salt.

A preferred ethylene/methacrylic acid copolymer sodium salt may have a molecular weight of 5 000 to 500 000, in particular 200 000 to 500 000 g/mol and 20 to 90%, in particular 20 to 40% of the original —COOH groups are preferably in the form of the sodium salt.

The compound of the formula (I) contains preferably two or more different metal cations. Combinations of an alkali metal cation or an earth alkali metal cation with a transition metal cation are of particular interest. The atomic ratio of these two different metal cations is for example 100:1 to 1:10, more preferably 50:1 to 1:5, and most preferably 20:1 to 1:1 or 9:1 to 1:1.

Of interest is a compound of the formula (I) which contains two different metal cations selected from the group consisting of the cations of Mn, Fe and Co.

According to another preferred embodiment of the present invention, the compound of the formula (I) contains two different metal cations; one metal cation is Li⁺, Na⁺, K⁺, Ca²⁺ or Zn²⁺_{1/2} and the other metal cation is selected from the group consisting of the cations of Mn, Fe and Co.

Examples of compounds of the formula (I) which improve the degradability of an agricultural article are:
I-1) polyacrylic acid manganese salt,
I-2) polyacrylic acid iron salt,
I-3) polyacrylic acid cobalt salt,
I-4) polyacrylic acid manganese/iron salt,
I-5) polyacrylic acid manganese/cobalt salt,
I-6) polyacrylic acid iron/cobalt salt,
I-7) polyacrylic acid lithium/manganese salt,
I-8) polyacrylic acid lithium/iron salt,
I-9) polyacrylic acid lithium/cobalt salt,
I-10) polyacrylic acid sodium/manganese salt,
I-11) polyacrylic acid sodium/iron salt,
I-12) polyacrylic acid sodium/cobalt salt,
I-13) polyacrylic acid potassium/manganese salt,
I-14) polyacrylic acid potassium/iron salt,
I-15) polyacrylic acid potassium/cobalt salt,
I-16) polyacrylic acid calcium/manganese salt,
I-17) polyacrylic acid calcium/iron salt,
I-18) polyacrylic acid calcium/cobalt salt,
I-19) polyacrylic acid zinc/manganese salt,
I-20) polyacrylic acid zinc/iron salt,
I-21) polyacrylic acid zinc/cobalt salt,
I-22) polymethacrylic acid manganese salt,
I-23) polymethacrylic acid iron salt,
I-24) polymethacrylic acid cobalt salt,
I-25) polymethacrylic acid manganese/iron salt,
I-26) polymethacrylic acid manganese/cobalt salt,
I-27) polymethacrylic acid iron/cobalt salt,
I-28) polymethacrylic acid lithium/manganese salt,
I-29) polymethacrylic acid lithium/iron salt,
I-30) polymethacrylic acid lithium/cobalt salt,
I-31) polymethacrylic acid sodium/manganese salt,
I-32) polymethacrylic acid sodium/iron salt,
I-33) polymethacrylic acid sodium/cobalt salt,
I-34) polymethacrylic acid potassium/manganese salt,
I-35) polymethacrylic acid potassium/iron salt,
I-36) polymethacrylic acid potassium/cobalt salt,
I-37) polymethacrylic acid calcium/manganese salt,
I-38) polymethacrylic acid calcium/iron salt,
I-39) polymethacrylic acid calcium/cobalt salt,
I-40) polymethacrylic acid zinc/manganese salt,
I-41) polymethacrylic acid zinc/iron salt,
I-42) polymethacrylic acid zinc/cobalt salt,
I-43) acrylic acid/methacrylic acid copolymer manganese salt,
I-44) acrylic acid/methacrylic acid copolymer iron salt,
I-45) acrylic acid/methacrylic acid copolymer cobalt salt,
I-46) acrylic acid/methacrylic acid copolymer manganese/iron salt,
I-47) acrylic acid/methacrylic acid copolymer manganese/cobalt salt,
I-48) acrylic acid/methacrylic acid copolymer iron/cobalt salt,
I-49) acrylic acid/methacrylic acid copolymer lithium/manganese salt,
I-50) acrylic acid/methacrylic acid copolymer lithium/iron salt,
I-51) acrylic acid/methacrylic acid copolymer lithium/cobalt salt,
I-52) acrylic acid/methacrylic acid copolymer sodium/manganese salt,
I-53) acrylic acid/methacrylic acid copolymer sodium/iron salt,
I-54) acrylic acid/methacrylic acid copolymer sodium/cobalt salt,
I-55) acrylic acid/methacrylic acid copolymer potassium/manganese salt,
I-56) acrylic acid/methacrylic acid copolymer potassium/iron salt,
I-57) acrylic acid/methacrylic acid copolymer potassium/cobalt salt,
I-58) acrylic acid/methacrylic acid copolymer calcium/manganese salt,
I-59) acrylic acid/methacrylic acid copolymer calcium/iron salt,
I-60) acrylic acid/methacrylic acid copolymer calcium/cobalt salt,
I-61) acrylic acid/methacrylic acid copolymer zinc/manganese salt,
I-62) acrylic acid/methacrylic acid copolymer zinc/iron salt,
I-63) acrylic acid/methacrylic acid copolymer zinc/cobalt salt,
I-64) ethylene/acrylic acid copolymer manganese salt,
I-65) ethylene/acrylic acid copolymer iron salt,
I-66) ethylene/acrylic acid copolymer cobalt salt,
I-67) ethylene/acrylic acid copolymer manganese/iron salt,
I-68) ethylene/acrylic acid copolymer manganese/cobalt salt,
I-69) ethylene/acrylic acid copolymer iron/cobalt salt,
I-70) ethylene/acrylic acid copolymer lithium/manganese salt,
I-71) ethylene/acrylic acid copolymer lithium/iron salt,
I-72) ethylene/acrylic acid copolymer lithium/cobalt salt,
I-73) ethylene/acrylic acid copolymer sodium/manganese salt,
I-74) ethylene/acrylic acid copolymer sodium/iron salt,
I-75) ethylene/acrylic acid copolymer sodium/cobalt salt,
I-76) ethylene/acrylic acid copolymer potassium/manganese salt,
I-77) ethylene/acrylic acid copolymer potassium/iron salt,
I-78) ethylene/acrylic acid copolymer potassium/cobalt salt,
I-79) ethylene/acrylic acid copolymer calcium/manganese salt,
I-80) ethylene/acrylic acid copolymer calcium/iron salt,
I-81) ethylene/acrylic acid copolymer calcium/cobalt salt,
I-82) ethylene/acrylic acid copolymer zinc/manganese salt,
I-83) ethylene/acrylic acid copolymer zinc/iron salt,
I-84) ethylene/acrylic acid copolymer zinc/cobalt salt,
I-85) ethylene/methacrylic acid copolymer manganese salt,
I-86) ethylene/methacrylic acid copolymer iron salt,
I-87) ethylene/methacrylic acid copolymer cobalt salt,
I-88) ethylene/methacrylic acid copolymer manganese/iron salt,
I-89) ethylene/methacrylic acid copolymer manganese/cobalt salt,
I-90) ethylene/methacrylic acid copolymer iron/cobalt salt,
I-91) ethylene/methacrylic acid copolymer lithium/manganese salt,
I-92) ethylene/methacrylic acid copolymer lithium/iron salt,
I-93) ethylene/methacrylic acid copolymer lithium/cobalt salt,
I-94) ethylene/methacrylic acid copolymer sodium/manganese salt,
I-95) ethylene/methacrylic acid copolymer sodium/iron salt,
I-96) ethylene/methacrylic acid copolymer sodium/cobalt salt,
I-97) ethylene/methacrylic acid copolymer potassium/manganese salt,
I-98) ethylene/methacrylic acid copolymer potassium/iron salt,
I-99) ethylene/methacrylic acid copolymer potassium/cobalt salt,
I-100) ethylene/methacrylic acid copolymer calcium/manganese salt,
I-101) ethylene/methacrylic acid copolymer calcium/iron salt,
I-102) ethylene/methacrylic acid copolymer calcium/cobalt salt,
I-103) ethylene/methacrylic acid copolymer zinc/manganese salt,
I-104) ethylene/methacrylic acid copolymer zinc/iron salt,
I-105) ethylene/methacrylic acid copolymer zinc/cobalt salt,

In the above examples the atomic ratio of the two metals is preferably 1:9 to 9:1.

According to a particular preferred embodiment of the present invention, component (b-I) is a polyacrylic acid sodium salt or an ethylene/acrylic acid copolymer manganese salt.

Component (b-II) is preferably a metal salt of a fatty acid with a carbon number ranging from C₂ to C₃₆, in particular from C₁₂ to C₃₆. Particularly preferred examples are metal carboxylates of palmitic acid (C₁₆), stearic acid (C₁₈), oleic acid (C₁₈), linoleic acid (C₁₈), linolenic acid (C₁₈) and naphthenic acid. Further examples of component (b-II) are aromatic acids, e.g. benzoic acid. Component (b-II) as C₂-C₃₆carboxylate, in particular stearate, palmitate or naphthenate, of Fe, Ce, Co, Mn or Ni is of particular interest.

A further preferred embodiment of the present invention relates to component (b-II) as a C₁₂-C₂₀alkanoate of Mn, or a C₁₂-C₂₀alkenoate of Mn.

According to a preferred embodiment of the present invention, component (b-II) contains two different metal salts, in particular with different metal cations, e.g. in a molar ratio of 1:9 to 9:1.

Examples of component (b-II) containing two different metal salts are the following mixtures:
II-1) Mn-stearate and Fe-stearate,
II-2) Mn-stearate and Co-stearate,
II-3) Mn-stearate and Ce-stearate,
II-4) Co-stearate and Fe-stearate,
II-5) Co-stearate and Ce-stearate,
II-6) Ce-stearate and Fe-stearate,
II-7) Mn-palmitate and Fe-palmitate,
II-8) Mn-palmitate and Co-palmitate,
II-9) Mn-palmitate and Ce-palmitate,
II-10) Co-palmitate and Fe-palmitate,
II-11) Co-palmitate and Ce-palmitate,
II-12) Ce-palmitate and Fe-palmitate,
II-13) Mn-naphthenate and Fe-naphthenate,
II-14) Mn-naphthenate and Co-naphthenate,
II-15) Mn-naphthenate and Ce-naphthenate,
II-16) Co-naphthenate and Fe-naphthenate,
II-17) Co-naphthenate and Ce-naphthenate,
II-18) Ce-naphthenate and Fe-naphthenate,
II-19) Mn-stearate and Mn-palmitate,
II-20) Mn-stearate and Fe-palmitate,
II-21) Mn-stearate and Co-palmitate,
II-22) Mn-stearate and Ce-palmitate,
II-23) Co-stearate and Fe-palmitate,
II-24) Co-stearate and Ce-palmitate,
II-25) Ce-stearate and Fe palmitate,
II-26) Mn-palmitate and Fe-stearate,
II-27) Mn-palmitate and Co stearate,
II-28) Mn palmitate and Ce-stearate,
II-29) Co-palmitate and Fe-stearate,
II-30) Co-palmitate and Ce-stearate,
II-31) Ce-palmitate and Fe-stearate,
II-32) Mn-naphthenate and Mn-stearate,
II-33) Mn-naphthenate and Fe-stearate,
II-34) Mn-naphthenate and Co-stearate,
II-35) Mn-naphthenate and Ce-stearate,
II-36) Co-naphthenate and Fe-stearate,
II-37) Co-naphthenate and Ce-stearate,
II-38) Ce-naphthenate and Fe-stearate.

Examples of mixtures which improve the degradability of an agricultural article are:
1) polyacrylic acid and Mn-stearate,
2) polyacrylic acid and Fe-stearate,
3) polyacrylic acid and Co-stearate,
4) polyacrylic acid and a 1:1 molar ratio of Mn-stearate/Fe-stearate mixture,
5) polyacrylic acid and a 4:1 molar ratio of Mn-stearate/Fe-stearate mixture,
6) polyacrylic acid and a 1:4 molar ratio of Mn-stearate/Fe-stearate mixture,
7) polyacrylic acid and a 1:1 molar ratio of Mn-stearate/Co-stearate mixture,
8) polyacrylic acid and a 4:1 molar ratio of Mn-stearate/Co-stearate mixture,
9) polyacrylic acid and a 1:4 molar ratio of Mn-stearate/Co-stearate mixture,
10) polyacrylic acid and a 1:1 molar ratio of Fe-stearate/Co-stearate mixture,
11) polyacrylic acid and a 4:1 molar ratio of Fe-stearate/Co-stearate mixture,
12) polyacrylic acid and a 1:4 molar ratio of Fe-stearate/Co-stearate mixture,
13) polyacrylic acid sodium salt and Mn-stearate,
14) polyacrylic acid sodium salt and Fe-stearate,
15) polyacrylic acid sodium salt and Co-stearate,
16) polyacrylic acid sodium salt and a 1:1 molar ratio of Mn-stearate/Fe-stearate mixture,
17) polyacrylic acid sodium salt and a 4:1 molar ratio of Mn-stearate/Fe-stearate mixture,
18) polyacrylic acid sodium salt and a 1:4 molar ratio of Mn-stearate/Fe-stearate mixture,
19) polyacrylic acid sodium salt and a 1:1 molar ratio of Mn-stearate/Co-stearate mixture,
20) polyacrylic acid sodium salt and a 4:1 molar ratio of Mn-stearate/Co-stearate mixture,
21) polyacrylic acid sodium salt and a 1:4 molar ratio of Mn-stearate/Co-stearate mixture,
22) polyacrylic acid sodium salt and a 1:1 molar ratio of Fe-stearate/Co-stearate mixture,
23) polyacrylic acid sodium salt and a 4:1 molar ratio of Fe-stearate/Co-stearate mixture,
24) polyacrylic acid sodium salt and a 1:4 molar ratio of Fe-stearate/Co-stearate mixture,
25) polyacrylic acid partial sodium salt and Mn-stearate,
26) polyacrylic acid partial sodium salt and Fe-stearate,
27) polyacrylic acid partial sodium salt and Co-stearate,
28) polyacrylic acid partial sodium salt and a 1:1 molar ratio of Mn-stearate/Fe-stearate mixture,
29) polyacrylic acid partial sodium salt and a 4:1 molar ratio of Mn-stearate/Fe-stearate mixture,
30) polyacrylic acid partial sodium salt and a 1:4 molar ratio of Mn-stearate/Fe-stearate mixture,
31) polyacrylic acid partial sodium salt and a 1:1 molar ratio of Mn-stearate/Co-stearate mixture,
32) polyacrylic acid partial sodium salt and a 4:1 molar ratio of Mn-stearate/Co-stearate mixture,
33) polyacrylic acid partial sodium salt and a 1:4 molar ratio of Mn-stearate/Co-stearate mixture,
34) polyacrylic acid partial sodium salt and a 1:1 molar ratio of Fe-stearate/Co-stearate mixture,
35) polyacrylic acid partial sodium salt and a 4:1 molar ratio of Fe-stearate/Co-stearate mixture,
36) polyacrylic acid partial sodium salt and a 1:4 molar ratio of Fe-stearate/Co-stearate mixture,
37) polymethacrylic acid and Mn-stearate,
38) polymethacrylic acid and Fe-stearate,
39) polymethacrylic acid and Co-stearate,
40) polymethacrylic acid and a 1:1 molar ratio of Mn-stearate/Fe-stearate mixture,
41) polymethacrylic acid and a 4:1 molar ratio of Mn-stearate/Fe-stearate mixture,
42) polymethacrylic acid and a 1:4 molar ratio of Mn-stearate/Fe-stearate mixture,
43) polymethacrylic acid and a 1:1 molar ratio of Mn-stearate/Co-stearate mixture,
44) polymethacrylic acid and a 4:1 molar ratio of Mn-stearate/Co-stearate mixture,
45) polymethacrylic acid and a 1:4 molar ratio of Mn-stearate/Co-stearate mixture,
46) polymethacrylic acid and a 1:1 molar ratio of Fe-stearate/Co-stearate mixture,
47) polymethacrylic acid and a 4:1 molar ratio of Fe-stearate/Co-stearate mixture,
48) polymethacrylic acid and a 1:4 molar ratio of Fe-stearate/Co-stearate mixture,
49) polymethacrylic acid sodium salt and Mn-stearate,
50) polymethacrylic acid sodium salt and Fe-stearate,
51) polymethacrylic acid sodium salt and Co-stearate,
52) polymethacrylic acid sodium salt and a 1:1 molar ratio of Mn-stearate/Fe-stearate mixture,
53) polymethacrylic acid sodium salt and a 4:1 molar ratio of Mn-stearate/Fe-stearate mixture,
54) polymethacrylic acid sodium salt and a 1:4 molar ratio of Mn-stearate/Fe-stearate mixture,
55) polymethacrylic acid sodium salt and a 1:1 molar ratio of Mn-stearate/Co-stearate mixture,
56) polymethacrylic acid sodium salt and a 4:1 molar ratio of Mn-stearate/Co-stearate mixture,
57) polymethacrylic acid sodium salt and a 1:4 molar ratio of Mn-stearate/Co-stearate mixture,
58) polymethacrylic acid sodium salt and a 1:1 molar ratio of Fe-stearate/Co-stearate mixture,
59) polymethacrylic acid sodium salt and a 4:1 molar ratio of Fe-stearate/Co-stearate mixture,
60) polymethacrylic acid sodium salt and a 1:4 molar ratio of Fe-stearate/Co-stearate mixture,
61) polymethacrylic acid partial sodium salt and Mn-stearate,
62) polymethacrylic acid partial sodium salt and Fe-stearate,
63) polymethacrylic acid partial sodium salt and Co-stearate,
64) polymethacrylic acid partial sodium salt and a 1:1 molar ratio of Mn-stearate/Fe-stearate mixture,
65) polymethacrylic acid partial sodium salt and a 4:1 molar ratio of Mn-stearate/Fe-stearate mixture,
66) polymethacrylic acid partial sodium salt and a 1:4 molar ratio of Mn-stearate/Fe-stearate mixture,
67) polymethacrylic acid partial sodium salt and a 1:1 molar ratio of Mn-stearate/Co-stearate mixture,
68) polymethacrylic acid partial sodium salt and a 4:1 molar ratio of Mn-stearate/Co-stearate mixture,
69) polymethacrylic acid partial sodium salt and a 1:4 molar ratio of Mn-stearate/Co-stearate mixture,
70) polymethacrylic acid partial sodium salt and a 1:1 molar ratio of Fe-stearate/Co-stearate mixture,
71) polymethacrylic acid partial sodium salt and a 4:1 molar ratio of Fe-stearate/Co-stearate mixture,
72) polymethacrylic acid partial sodium salt and a 1:4 molar ratio of Fe-stearate/Co-stearate mixture,
73) acrylic acid/methacrylic acid copolymer and Mn-stearate,
74) acrylic acid/methacrylic acid copolymer and Fe-stearate,
75) acrylic acid/methacrylic acid copolymer and Co-stearate,
76) acrylic acid/methacrylic acid copolymer and a 1:1 molar ratio of Mn-stearate/Fe-stearate mixture,
77) acrylic acid/methacrylic acid copolymer and a 4:1 molar ratio of Mn-stearate/Fe-stearate mixture,
78) acrylic acid/methacrylic acid copolymer and a 1:4 molar ratio of Mn-stearate/Fe-stearate mixture,
79) acrylic acid/methacrylic acid copolymer and a 1:1 molar ratio of Mn-stearate/Co-stearate mixture,
80) acrylic acid/methacrylic acid copolymer and a 4:1 molar ratio of Mn-stearate/Co-stearate mixture,
81) acrylic acid/methacrylic acid copolymer and a 1:4 molar ratio of Mn-stearate/Co-stearate mixture,
82) acrylic acid/methacrylic acid copolymer and a 1:1 molar ratio of Fe-stearate/Co-stearate mixture,
83) acrylic acid/methacrylic acid copolymer and a 4:1 molar ratio of Fe-stearate/Co-stearate mixture,
84) acrylic acid/methacrylic acid copolymer and a 1:4 molar ratio of Fe-stearate/Co-stearate mixture,
85) acrylic acid/methacrylic acid copolymer sodium salt and Mn-stearate,
86) acrylic acid/methacrylic acid copolymer sodium salt and Fe-stearate,
87) acrylic acid/methacrylic acid copolymer sodium salt and Co-stearate,
88) acrylic acid/methacrylic acid copolymer sodium salt and a 1:1 molar ratio of Mn-stearate/Fe-stearate mixture,
89) acrylic acid/methacrylic acid copolymer sodium salt and a 4:1 molar ratio of Mn-stearate/Fe-stearate mixture,
90) acrylic acid/methacrylic acid copolymer sodium salt and a 1:4 molar ratio of Mn-stearate/Fe-stearate mixture,
91) acrylic acid/methacrylic acid copolymer sodium salt and a 1:1 molar ratio of Mn-stearate/Co-stearate mixture,
92) acrylic acid/methacrylic acid copolymer sodium salt and a 4:1 molar ratio of Mn-stearate/Co-stearate mixture,
93) acrylic acid/methacrylic acid copolymer sodium salt and a 1:4 molar ratio of Mn-stearate/Co-stearate mixture,
94) acrylic acid/methacrylic acid copolymer sodium salt and a 1:1 molar ratio of Fe-stearate/Co-stearate mixture,
95) acrylic acid/methacrylic acid copolymer sodium salt and a 4:1 molar ratio of Fe-stearate/Co-stearate mixture,
96) acrylic acid/methacrylic acid copolymer sodium salt and a 1:4 molar ratio of Fe-stearate/Co-stearate mixture,
97) acrylic acid/methacrylic acid copolymer partial sodium salt and Mn-stearate,
98) acrylic acid/methacrylic acid copolymer partial sodium salt and Fe-stearate,
99) acrylic acid/methacrylic acid copolymer partial sodium salt and Co-stearate,
100) acrylic acid/methacrylic acid copolymer partial sodium salt and a 1:1 molar ratio of Mn-stearate/Fe-stearate mixture,
101) acrylic acid/methacrylic acid copolymer partial sodium salt and a 4:1 molar ratio of Mn-stearate/Fe-stearate mixture,
102) acrylic acid/methacrylic acid copolymer partial sodium salt and a 1:4 molar ratio of Mn-stearate/Fe-stearate mixture,
103) acrylic acid/methacrylic acid copolymer partial sodium salt and a 1:1 molar ratio of Mn-stearate/Co-stearate mixture,
104) acrylic acid/methacrylic acid copolymer partial sodium salt and a 4:1 molar ratio of Mn-stearate/Co-stearate mixture,
105) acrylic acid/methacrylic acid copolymer partial sodium salt and a 1:4 molar ratio of Mn-stearate/Co-stearate mixture,
106) acrylic acid/methacrylic acid copolymer partial sodium salt and a 1:1 molar ratio of Fe-stearate/Co-stearate mixture,
107) acrylic acid/methacrylic acid copolymer partial sodium salt and a 4:1 molar ratio of Fe-stearate/Co-stearate mixture,
108) acrylic acid/methacrylic acid copolymer partial sodium salt and a 1:4 molar ratio of Fe-stearate/Co-stearate mixture,
109) ethylene/acrylic acid copolymer sodium salt and Mn-stearate,
110) ethylene/acrylic acid copolymer sodium salt and Fe-stearate,
111) ethylene/acrylic acid copolymer sodium salt and Co-stearate,
112) ethylene/acrylic acid copolymer sodium salt and a 1:1 molar ratio of Mn-stearate/Fe-stearate mixture,
113) ethylene/acrylic acid copolymer sodium salt and a 4:1 molar ratio of Mn-stearate/Fe-stearate mixture,
114) ethylene/acrylic acid copolymer sodium salt and a 1:4 molar ratio of Mn-stearate/Fe-stearate mixture,
115) ethylene/acrylic acid copolymer sodium salt and a 1:1 molar ratio of Mn-stearate/Co-stearate mixture,
116) ethylene/acrylic acid copolymer sodium salt and a 4:1 molar ratio of Mn-stearate/Co-stearate mixture,
117) ethylene/acrylic acid copolymer sodium salt and a 1:4 molar ratio of Mn-stearate/Co-stearate mixture,
118) ethylene/acrylic acid copolymer sodium salt and a 1:1 molar ratio of Fe-stearate/Co-stearate mixture,
119) ethylene/acrylic acid copolymer sodium salt and a 4:1 molar ratio of Fe-stearate/Co-stearate mixture,
120) ethylene/acrylic acid copolymer sodium salt and a 1:4 molar ratio of Fe-stearate/Co-stearate mixture,
121) ethylene/acrylic acid copolymer partial sodium salt and Mn-stearate,
122) ethylene/acrylic acid copolymer partial sodium salt and Fe-stearate,
123) ethylene/acrylic acid copolymer partial sodium salt and Co-stearate,
124) ethylene/acrylic acid copolymer partial sodium salt and a 1:1 molar ratio of Mn-stearate/Fe-stearate mixture,
125) ethylene/acrylic acid copolymer partial sodium salt and a 4:1 molar ratio of Mn-stearate/Fe-stearate mixture,
126) ethylene/acrylic acid copolymer partial sodium salt and a 1:4 molar ratio of Mn-stearate/Fe-stearate mixture,
127) ethylene/acrylic acid copolymer partial sodium salt and a 1:1 molar ratio of Mn-stearate/Co-stearate mixture,
128) ethylene/acrylic acid copolymer partial sodium salt and a 4:1 molar ratio of Mn-stearate/Co-stearate mixture,
129) ethylene/acrylic acid copolymer partial sodium salt and a 1:4 molar ratio of Mn-stearate/Co-stearate mixture,
130) ethylene/acrylic acid copolymer partial sodium salt and a 1:1 molar ratio of Fe-stearate/Co-stearate mixture,
131) ethylene/acrylic acid copolymer partial sodium salt and a 4:1 molar ratio of Fe-stearate/Co-stearate mixture,
132) ethylene/acrylic acid copolymer partial sodium salt and a 1:4 molar ratio of Fe-stearate/Co-stearate mixture,
133) ethylene/methacrylic acid copolymer sodium salt and Mn-stearate,
134) ethylene/methacrylic acid copolymer sodium salt and Fe-stearate,
135) ethylene/methacrylic acid copolymer sodium salt and Co-stearate,
136) ethylene/methacrylic acid copolymer sodium salt and a 1:1 molar ratio of Mn-stearate/Fe-stearate mixture,
137) ethylene/methacrylic acid copolymer sodium salt and a 4:1 molar ratio of Mn-stearate/Fe-stearate mixture,
138) ethylene/methacrylic acid copolymer sodium salt and a 1:4 molar ratio of Mn-stearate/Fe-stearate mixture,
139) ethylene/methacrylic acid copolymer sodium salt and a 1:1 molar ratio of Mn-stearate/Co-stearate mixture,
140) ethylene/methacrylic acid copolymer sodium salt and a 4:1 molar ratio of Mn-stearate/Co-stearate mixture,
141) ethylene/methacrylic acid copolymer sodium salt and a 1:4 molar ratio of Mn-stearate/Co-stearate mixture,
142) ethylene/methacrylic acid copolymer sodium salt and a 1:1 molar ratio of Fe-stearate/Co-stearate mixture,
143) ethylene/methacrylic acid copolymer sodium salt and a 4:1 molar ratio of Fe-stearate/Co-stearate mixture,
144) ethylene/methacrylic acid copolymer sodium salt and a 1:4 molar ratio of Fe-stearate/Co-stearate mixture,
145) ethylene/methacrylic acid copolymer partial sodium salt and Mn-stearate,
146) ethylene/methacrylic acid copolymer partial sodium salt and Fe-stearate,
147) ethylene/methacrylic acid copolymer partial sodium salt and Co-stearate,
148) ethylene/methacrylic acid copolymer partial sodium salt and a 1:1 molar ratio of Mn-stearate/Fe-stearate mixture,
149) ethylene/methacrylic acid copolymer partial sodium salt and a 4:1 molar ratio of Mn-stearate/Fe-stearate mixture,
150) ethylene/methacrylic acid copolymer partial sodium salt and a 1:4 molar ratio of Mn-stearate/Fe-stearate mixture,
151) ethylene/methacrylic acid copolymer partial sodium salt and a 1:1 molar ratio of Mn-stearate/Co-stearate mixture,
152) ethylene/methacrylic acid copolymer partial sodium salt and a 4:1 molar ratio of Mn-stearate/Co-stearate mixture,
153) ethylene/methacrylic acid copolymer partial sodium salt and a 1:4 molar ratio of Mn-stearate/Co-stearate mixture,
154) ethylene/methacrylic acid copolymer partial sodium salt and a 1:1 molar ratio of Fe-stearate/Co-stearate mixture,
155) ethylene/methacrylic acid copolymer partial sodium salt and a 4:1 molar ratio of Fe-stearate/Co-stearate mixture,
156) ethylene/methacrylic acid copolymer partial sodium salt and a 1:4 molar ratio of Fe-stearate/Co-stearate mixture,

Polyacrylic acid partial sodium salt means that for example only 2 to 50%, preferably 4 to 25%, in particular 5 to 15%, of the —COOH groups of the polyacrylic acid have been converted into the Na salt.

Ethylene/methacrylic acid copolymer partial sodium salt means that for example 20 to 80%, in particular 20 to 40% of the —COOH groups of the ethylene/methacrylic acid copolymer have been converted into the Na salt.

A particular preferred embodiment of the present invention relates to an agricultural article wherein component (b-I) is an alkali salt of polyacrylic acid, preferably a polyacrylic acid sodium salt, or an alkali salt of ethylene/methacrylic acid copolymer, preferably an ethylene/methacrylic acid copolymer sodium salt, in particular an ethylene/methacrylic acid copolymer partial sodium salt, and

component (b-II) is manganese stearate.

The additive mixture used according to the present invention may further contain one or more conventional additives. Examples are:

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of 13-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenyl propionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide(Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenyl-amines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

### 2. UV Absorbers and Light Stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethyl benzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂┘, where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethyl-piperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyl-oxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylene-diamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-d ioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-1 2-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos 168, Ciba-Geigy), tris(nonylphenyl) phosphite,

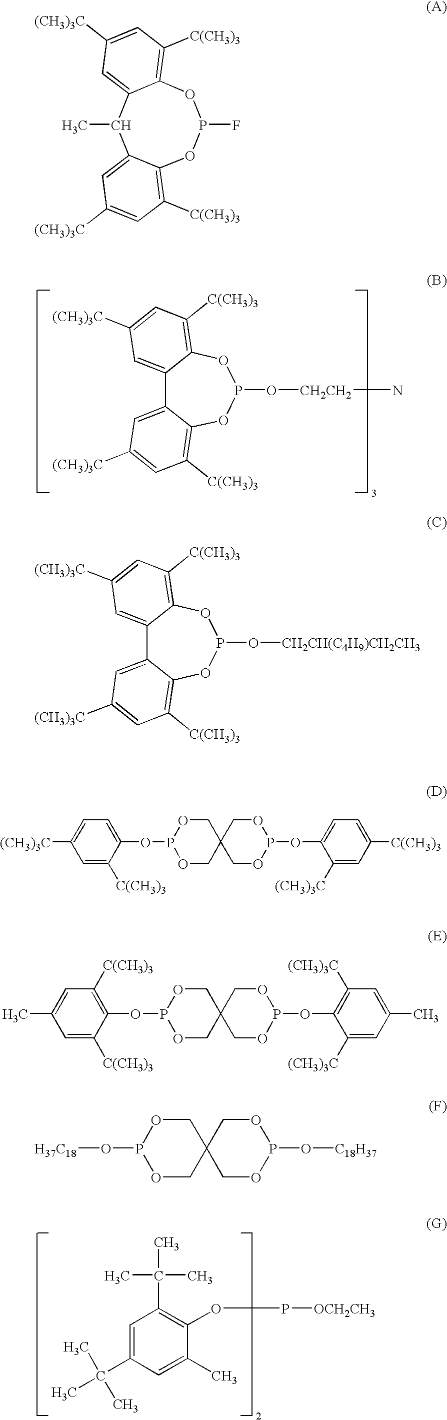

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

9. Polyamide stabilisers, for example copper salts in combination with iodides and/or phosphorus compounds and salts of divalent manganese.

10. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one.

The conventional additive is for example present in the composition in an amount of 0.001 to 10% by weight, preferably 0.001 to 5% by weight, relative to the weight of the organic polymer (component (a)).

A composition, which contains in addition one or more of the following components:

(b-III) a filler or reinforcing agent,
(b-IV) a pigment,
(b-V) a light stabilizer,
(b-VI) a processing additive,
(b-VII) an antioxidant,
(b-VIII) an inorganic or organic salt of Ca, Mg, Zn or Al, or an oxide of Ca, Mg, Zn or Al,
(b-IX) a terpene derivative,
is preferred.

Examples of the components (b-III) to (b-VII) are disclosed in detail in US-A-2003-0236325 which is incorporated by reference herein.

Component (b-III) covers e.g. calcium carbonate, silicas, glass fibres, glass bulbs, talc, kaolin, mica, barium sulfate, metal oxides and hydroxides, carbon black, graphite, wood flour, flours of other natural products, synthetic fibers and metal stearates used as fillers such as calcium stearate or zinc stearate; unsaturated organic polymers such as polybutadiene, polyisoprene, polyoctenamer, or unsaturated acids such as stearic acid, oleic acid, linoleic acid or linolenic acid; and further polymers such as polyethylene oxide or polypropylene oxide.

Component (b-IV) is for example carbon black, titanium dioxide (anatase or rutile which may range in particle size from e.g. 1000 μm to 10 nm and which may optionally be surface treated) or another organic or inorganic colour pigment frequently used in agricultural applications (for example carbon black, brown, silver, red, green).

Component (b-V) is preferably a hindered amine light stabilizer (HALS) or an UV absorber. Examples of preferred hindered amine light stabilizers are also those compounds which are disclosed for example as components (A), (B) and (C) in WO-A-01/92,392 which is incorporated by reference herein and which is equivalent to U.S. patent application Ser. No. 10/257,339.

Component (b-VI) is for example an antislip/antiblock additive, a plasticizer (e.g. polyglycol), an optical brightener, an antistatic agent, a blowing agent or a process stabilizer.

Component (b-VII) is for example a phenolic antioxidant.

Component (b-VIII) is for example a metal stearate, e.g. calcium stearate or zinc stearate; or zinc oxide (which may range in particle size from e.g. 1000 μm to 10 nm and which may optionally be surface treated).

The polyterpene resins used as component (b-IX) may be of natural or synthetic origin. They are either commercially available or can be prepared according to known methods.

The polyterpene resins are for example based on acyclic terpenes or cyclic terpenes, e.g. monocyclic terpenes or bicyclic terpenes. Polyterpenes based on terpene hydrocarbons are preferred.

Examples of acyclic terpenes are

terpene hydrocarbons, e.g.
myrcene, ocimene and beta-farnesene;
terpene alcohols, e.g.
dihydromyrcenol (2,6-dimethyl-7-octen-2-ol), geraniol (3,7-dimethyl-trans-2,6-octadien-1-ol), nerol (3,7-dimethyl-cis-2,6-octadien-1-ol), linalool (3,7-dimethyl-1,6-octadien-3-ol), myrcenol (2-methyl-6-methylene-7-octen-2-ol), lavandulol, citronellol (3,7-dimethyl-6-octen-1-ol), trans-trans-farnesol (3,7,11-trimethyl-2,6,10-dodecatrien-1-ol) and trans-nerolidol (3,7,11-trimethyl-1,6,10-dodecatrien-3-ol);
terpene aldehydes and acetals, e.g.
citral (3,7-dimethyl-2,6-octadien-1-al), citral diethyl acetal (3,7-dimethyl-2,6-octadien-1-aldiethyl acetal), citronellal (3,7-dimethyl-6-octen-1-al), citronellyloxyacetaldehyde and 2,6,10-trimethyl-9-undecenal;
terpene ketones, e.g.
tagetone, solanone and geranylacetone (6,10-dimethyl-5,9-undecadien-2-one);
terpene acids and esters, e.g.
cis-geranic acid, citronellic acid, geranyl esters (including geranyl formate, geranyl acetate, geranyl propionate, geranyl isobutyrate and geranyl isovalerate), neryl esters (including neryl acetate), linalyl esters (including linalyl formate, linalyl acetate, linalyl propionate, linalyl butyrate and linalyl isobutyrate), lavandulyl esters (including lavandulyl acetate), citronellyl esters (including citronellyl formate, citronellyl acetate, cintronellyl propionate, citronellyl isobutyrate, citronellyl isovalerate and citronellyl tiglate); and
nitrogen containing unsaturated terpene derivatives, e.g.
cis-geranic acid nitrile and citronellic acid nitrile.

Examples of cyclic terpenes are

cyclic terpene hydrocarbons, e.g.
limonene (1,8-p-methadiene), alpha-terpinene, gamma-terpinene (1,4-p-menthadiene), terpinolene, alpha-phellandrene (1,5-p-menthadiene), beta-phellandrene, alpha-pinene (2-pinene), beta-pinene (2(10)-pinene), camphene, 3-carene, caryophyllene, (+)-valencene, thujopsene, alpha-cedrene, beta-cedrene and longifolene;
cyclic terpene alcohols and ethers, e.g.
(+)-neoiso-isopulegol, isopulegol (8-p-menten-3-ol), alpha-terpineol (1-p-menten-8-ol), beta-terpineol, gamma-terpineol, delta-terpineol and 1-terpinen-4-ol (1-p-menten-4-ol);
cyclic terpene aldehydes and ketones, e.g.
carvone (1,8-p-mantadien-6-one), alpha-ionone (C₁₃H₂₀O), beta-ionone (C₁₃H₂₀O), gamma-ionone (C₁₃H₂₀O), irone (alpha-, beta-, gamma-) (C₁₄H₂₂O), n-methylionone (alpha-, beta-, gamma-) (C₁₄H₂₂O), isomethylionone (alpha-, beta-, gamma-) (C₁₄H₂₂O), allylionone (C₁₆H₂₄O), pseudoionone, n-methylpseudoionone, isomethylpseudoionone, damascones (1-(2,6,6-trimethylcycohexenyl)-2-buten-1-ones; including beta-damascenone (1-(2,6,6-trimethyl-1,3-cyclohad ienyl)-2-buten-1-one)), nootkatone (5,6-dimethyl-8-isopropenylbicyclo[4.4.0]-1-decen-3-one) and cedryl methyl ketone (C₁₇H₂₆O); and
cyclic terpene esters, e.g.
alpha-terpinyl acetate(1-p-menthen-8-yl acetate), nopyl acetate((−)-2-(6,6-dimethylbicyclo[3.1.1]hept-2-en-2-yl)ethyl acetate) and khusymil acetate.

Further suitable terpene derivatives can be found in Kirk-Othmer, Encyclopedia of Chemical Technology, John Wiley & Sons, 4. ed. (1994), Vol. 23, p. 833-882.

Preferred examples of terpenes which can serve as the basis for the polyterpenes are tricyclene, alpha-pinene, alpha-fenchene, camphene, beta-pinene, myrcene, cis-pinane, cis/trans-p-8-menthene, trans-2-p-menthene, p-3-menthene, trans-p-menthane, 3-carene, cis-p-menthane, 1,4-cineole, 1,8-cineole, alpha-terpinene, p-1-menthene, p-4(8)-menthene, limonene, p-cymene, gamma-terpinene, p-3,8-menthadiene, p-2,4(8)-menthadiene and terpinolene.

Further examples of component (b-IX) are cycloaliphatic compounds structurally related to terpenes such as the following

alcohols, e.g.
5-(2,2,3-trimethyl-3-cyclopenten-1-yl)-3-methylpentan-2-ol;
aldehydes. e.g.
2,4-dimethyl-3-cyclohexene carboxaldehyde, 4-(4-methyl-3-penten-1-yl)-3-cyclohexene carboxaldehyde and 4-(4-hydroxy-4-methylpentyl)-3-cyclohexene carboxaldehyde;
ketones, e.g.
civetone, dihydrojasmone (3-methyl-2-pentyl-2-cyclopenten-1-one), cis-jasmone (3-methyl-2-(2-cis-penten-1-yl)-2-cyclopenten-1-one), 5-cyclohexadecen-1-one, 2,3,8,8-tetramethyl-1,2,3,4,5,6,7,8-octahydro-2-napthalenyl methyl ketone and 3-methyl-2-cyclopenten-2-ol-1-one; and
esters, e.g.
4,7-methano-3a,4,5,6,7,7a-hexahydro-5-(or 6)-indenyl acetate, allyl 3-cyclohexylpropionate, methyl dihydrojasmonate methyl (3-oxo-2-pentylcyclopentyl)acetate.

The polyterpenes used in the present invention may also be derived from the copolymerisation of the aforementioned terpenes with other unsaturated organic compounds.

Other examples of component (b-IX) are the unsaturated coal-tar by-product polymers such as cumarone-indene resins, rosin and the like.

Present component (b-IX) is preferably a polyterpene resin selected from the group consisting of poly-alpha-pinene, poly-beta-pinene, polylimonene or a copolymer of alpha-pinene, a copolymer of beta-pinene or a copolymer of limonene. Poly-beta-pinene is particularly preferred.

Terpene-based hydrocarbon resins are typically based on products such as alpha-pinene, beta-pinene and d-limonene, which are obtained from the wood and citrus industry, respectively. Terpene-based resins have been available since the mid-1930s (Kirk-Othmer, Encyclopedia of Chemical Technology, John Wiley & Sons, 4. ed. (1994), Vol. 13, p. 717-718). Polymerization of monoterpenes is most commonly accomplished by carbocationic polymerization utilizing Friedel-Crafts-type catalyst systems, such as aluminum chloride (Kirk-Othmer, Encyclopedia of Chemical Technology, John Wiley & Sons, 4. ed. (1994), Vol. 1, p. 459).

In general, the polyterpenes of the present invention have more than one terpene unit. They have preferably a molecular weight of about 400 g/mol to about 1400 g/mol.

Examples of component (a) are

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers, ethylene/vinyl alcohol copolymers (EVOH) or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethyllene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Poly-amide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Component (a) is preferably a thermoplastic natural or synthetic polymer.

Preferred examples of component (a) are:

1) Homo and copolymers of olefin monomers such as ethylene and propylene, but also higher 1-olefins such as 1-butene, 1-pentene, 1-hexene or 1-octene. Preferred is polyethylene LDPE and LLDPE, HDPE and polypropylene.
2) Homo- and copolymers of olefin monomers with diolefin monomers such as butadiene, isoprene and cyclic olefins such as norbornene.
3) Copolymers of one or more 1-olefins and/or diolefins with carbon monoxide and/or with other vinyl monomers, including, but not limited to, vinyl acetate, vinyl ketone, styrene, maleic acid anhydride and vinyl chloride.
4) Polyvinyl alcohol
5) Other thermoplastics such as polystyrene, styrene-acrylonitrile copolymer, acrylonitrile-butadiene-styrene copolymer, polyvinyl chloride, polyvinylidene chloride, polyvinyl acetate, polyvinylbutyral, ethylene-vinyl alcohol copolymer, polyethylene terephthalate (PET), polybutylene terephthalate (PBT), liquid crystal polyesters (LCP's), polyacetals (e.g., POM), polyamides (PA), polycarbonates, polyurethane and polyphenylene sulfide (PPS); polymer blends or polymer alloys formed of two or more of these resins; and compounds obtained by adding fillers such as glass fibers, carbon fibers, semi-carbonized fibers, cellulose fibers and glass beads, flame retardants, blowing agents, antimicrobial agents, crosslinking agents, fine polyolefin resin powder, polyolefin waxes, ethylene bisamide waxes, metallic soaps and the like either singly or in combination to these resins. Examples of thermosetting resins, on the other hand, can include thermosetting resins such as epoxy resins, melamine resins and unsaturated polyester resins; and compounds obtained by incorporating fillers such as glass fibers, carbon fibers, semi-carbonized fibers, cellulose fibers and glass beads, flame retardants and the like either singly or in combination to these resins.

Polyolefins, in particular polyethylene, are of special interest.

According to a preferred embodiment of the present invention component (a) is a polyolefin homo- or copolymer, a starch modified polyolefin or a starch based polymer composite, in particular polyethylene, polypropylene, a polyethylene copolymer or a polypropylene copolymer.

A further preferred example of component (a) is

a degradable polymer selected from the group consisting of a polyester, thermoplastic aliphatic or partially aromatic polyester urethanes, aliphatic or aliphatic-aromatic polyester carbonates and aliphatic or partially aromatic polyester amides, a polyvinyl alcohol or blends thereof; or
a blend of one or more of the afore mentioned polymers with natural or modified starch, polysaccharides, lignin, wood flour, cellulose or chitin; or
a graft polymer.

Still further examples of component (a) are polyethylensuccinate, polybutylensuccinate, polybutylensuccinate/ad ipate, polybutylensuccinate/carbonate, polybutylensuccinate/terephtalate, polybutylenead ipate/terephthalate, polytetramethyleneadipate/terephthalate, polybutyleneadipate/terephthalate, polycaprolactone, poly(hydroxyalcanoates), e.g. poly 3-hydroxybutyrate, poly-3-hydroxybutyrate/octanoate copolymer, poly-3-hydroxybutyrate/hexanoate/decanoate terpolymer, and polylactic acid.

Examples of degradable polymers are cited in several articles, e.g. G. Hinrichsen et al., Macromol. Mater. Eng., 276/277, 1-24 (2000) and M. Flieger et al., Folia Microbiol. 48(1), 27-44 (2003). A comprehensive summary on degradable polyesters is given in Bioploymers, Volumes 3a, 3b and 4, of A. Steinbuechel, Y. Doi (8. eds.), Wiley VCH, Weinheim (2001).

Examples of thermoplastic aliphatic or partially aromatic polyester urethanes, aliphatic or aliphatic-aromatic polyester carbonates and aliphatic or partially aromatic polyester amides are given e.g. in U.S. Pat. No. 6,307,003. Further examples of degradable polyurethanes are given in U.S. Pat. Nos. 5,961,906 and 5,898,049. Examples of degradable polyester amides are given in U.S. Pat. No. 5,512,339. The indicated US patents are incorporated by reference herein.

The origin of the degradable polymer may either be chemical, by fermentation or by production in genetically modified plants.

Component (b-I) is preferably present in the organic polymer (=component (a)) in an amount of 0.001 to 5% by weight or 0.005 to 5% by weight, in particular 0.1 to 3% by weight, relative to the weight of the organic polymer.

Component (b-II) is preferably present in the organic polymer (=component (a)) in an amount of 0.005 to 50% by weight or 0.005 to 10% by weight, in particular 0.005 to 5% by weight, relative to the weight of the organic polymer.

Component (b-III) is preferably present in the organic polymer (=component (a)) in an amount of 0.05 to 80% by weight, in particular 0.5 to 70% by weight, relative to the weight of the organic polymer.

Component (b-IV) is preferably present in the organic polymer (=component (a)) in an amount of 0.05 to 40% by weight, in particular 0.5 to 30% by weight, relative to the weight of the organic polymer.

Component (b-V) is preferably present in the organic polymer (=component (a)) in an amount of 0.01 to 20% by weight, in particular 0.01 to 10% by weight, relative to the weight of the organic polymer.

Component (b-VI) is preferably present in the organic polymer (=component (a)) in an amount of 0.05 to 10% by weight, in particular 0.05 to 5% by weight, relative to the weight of the organic polymer.

Component (b-VII) is preferably present in the organic polymer (=component (a)) in an amount of 0.001 to 4% by weight, e.g. 0.005 to 1% by weight, in particular 0.01 to 0.3% by weight, relative to the weight of the organic polymer.

Component (b-VIII) is preferably present in the organic polymer (=component (a)) in an amount of 0.005 to 5% by weight, in particular 0.05 to 1% by weight, relative to the weight of the organic polymer.

Component (b-IX) is preferably present in the organic polymer (=component (a)) in an amount of 0.01 to 10% by weight, in particular 0.01 to 5% by weight, relative to the weight of the organic polymer.

The components (b-I) and optionally (b-II) to (b-IX) can be incorporated into the organic polymer (=component (a)) in a controlled form by known methods, for example before or during shaping or by applying the dissolved or dispersed compounds to the organic polymer, if necessary with subsequent evaporation of the solvent. The components can be added to the organic polymer in the form of a powder, granules or a masterbatch, which contains these components in, for example, a concentration of from 2.5 to 25% by weight.

A further embodiment of the present invention is a masterbatch containing

(a) an organic polymer
(b) 10 to 70%, relative to the weight of the organic polymer, of an additive mixture containing
(b-I) a compound of the formula (I) as defined in claim 1 and
(b-II) C₂-C₃₆-carboxylate of Fe, Ce, Co, Mn or Ni;
for the preparation of an agricultural article as defined in claim 1.

Another embodiment of the present invention is a masterbatch containing

(a) a linear low density polyethylene,
(b) 3 to 60% by weight, relative to the weight of the linear low density polyethylene, of an additive mixture containing
(b-I) a sodium salt of polyacrylic acid or a sodium salt of ethylene/methacrylic acid copolymer and
(b-II) manganese stearate.

Preferred is a masterbatch as defined above, containing

(a) a linear low density polyethylene,
(b-I) 2 to 10% by weight, relative to the weight of the linear low density polyethylene, of a sodium salt of a polyacrylic acid,
(b-II) 1 to 5% by weight, relative to the weight of the linear low density polyethylene, of manganese stearate,
(b-III) 2 to 10% by weight, relative to the weight of the linear low density polyethylene, of calcium stearate.

Also preferred is a masterbatch as defined above, containing

(a) a linear low density polyethylene,
(b-I) 30 to 50% by weight, relative to the weight of the linear low density polyethylene, of a sodium salt of ethylene/methacrylic acid copolymer,
(b-II) 1 to 5% by weight, relative to the weight of the linear low density polyethylene, of manganese stearate.

If desired, the components (b-I) and optionally (b-II) to (b-IX) can be blended with each other before incorporation into the organic polymer (=component (a)). They can be added to the organic polymer before or during the polymerization or before the crosslinking.

The present invention is especially useful in all areas where degradation in humid environments is desired. The use of the present additive mixture can be tailored according to the climatic conditions of the place where an article made of the above described composition will be finally stored for degradation.

A brief description of some exemplary articles made in accordance with the invention follows. Typically, the articles are required to have a relatively long service life followed by a relatively short period during which embrittlement and fragmentation occurs, either in situ or in a landfill. The articles may be film products comprising polyolefins or other organic polymers.

Examples of suitable agricultural articles are mulch films, small tunnel films, banana bags, direct covers, nonwoven, twines, clips, nettings, pipes, tubes and pots.

In all of the foregoing examples, the article, made in accordance with the invention, will keep its properties during use and will degrade after its service life.

Mulch films represent a particular preferred embodiment of the present invention.

Mulch films are used to protect crops in the early stages of their development. Mulch films, depending on the type of crop and on the purpose, can be laid after the seeding or at the same time as the seeding. They protect the crop until the crop has reached a certain development stage. When the harvest is finished, the field is prepared for another cultivation.

Standard plastic films have to be collected and disposed in order to allow the new cultivation. The additive systems of the present invention (components (b-I) and optionally (b-II) to (b-IX)), when added to the standard plastic mulch films, allow the film to keep its properties until the crop has reached the required development, then degradation starts and the film is completely embrittled when the new cultivation has to be started.

The length of the service period and of the time to degradation and time to complete disappearance depends on the type of crop and on the environmental conditions. Depending on the specific time requirements, the additive combinations are designed.

By appropriately dosing the amount of the present additive system, the required service periods and time to degradation and disappearance can be obtained. Examples of typical life times of mulch films are 10 to 180 days, lifes up to 24 months can also be required and achieved.

Thus, a further preferred embodiment of the present invention is a mulch film containing the components (b-I) and optionally (b-II) to (b-IX) as defined above and having a life time of 10 to 720 days.

Mulch films can be mono or multilayer (preferably three layers), transparent or appropriately pigmented (white, black, silver, green, brown) on the base of the agronomic needs.

The thickness of the mulch films can range, for example, between 5 to 100 microns. Films from 10 to 60 microns are preferred. Blown films are particularly preferred.

Further preferred embodiments of the present invention relate to

A) An agricultural article as described above, made of
a composition containing
(a) polyethylene
(b-I) the sodium salt of ethylene/methacrylic acid copolymer, and
(b-II) Mn stearate;
   in particular
(a) polyethylene
(b-I) the sodium salt of ethylene/methacrylic acid copolymer having a molecular weight of 200 000 to 500 000 g/mol and 20 to 40% of the —COOH groups of the ethylene/methacrylic acid copolymer being in the form of the sodium salt, and
(b-II) Mn stearate;
   or
(a) polyethylene,
(b-I) the sodium salt of ethylene/methacrylic acid copolymer,
(b-II) Mn stearate, and
(b-IV) carbon black;
   in particular
(a) polyethylene,
(b-I) the sodium salt of ethylene/methacrylic acid copolymer having a molecular weight of 200 000 to 500 000 g/mol and 20 to 40% of the —COOH groups of the ethylene/methacrylic acid copolymer being in the form of the sodium salt, and
(b-II) Mn stearate, and
(b-IV) carbon black;
   or
(a) polyethylene,
(b-I) the sodium salt of ethylene/methacrylic acid copolymer,
(b-II) Mn stearate, and
(b-V) a sterically hindered amine light stabilizer;
   in particular
(a) polyethylene,
(b-I) the sodium salt of ethylene/methacrylic acid copolymer having a molecular weight of 200 000 to 500 000 g/mol and 20 to 40% of the —COOH groups of the ethylene/methacrylic acid copolymer being in the form of the sodium salt, and
(b-II) Mn stearate, and
(b-V) a sterically hindered amine light stabilizer;
   or
(a) polyethylene,
(b-I) the sodium salt of ethylene/methacrylic acid copolymer,
(b-II) Mn stearate,
(b-IV) carbon black, and
(b-V) a sterically hindered amine light stabilizer;
   in particular
(a) polyethylene,
(b-I) the sodium salt of ethylene/methacrylic acid copolymer having a molecular weight of 200 000 to 500 000 g/mol and 20 to 40% of the —COOH groups of the ethylene/methacrylic acid copolymer being in the form of the sodium salt, and
(b-II) Mn stearate,
(b-IV) carbon black, and
(b-V) a sterically hindered amine light stabilizer;
   or
(a) a polyolefin,
(b-I) the sodium salt of polyacrylic acid, and
(b-II) Mn stearate;
   or
(a) polyolefin,
(b-I) the sodium salt of polyacrylic acid,
(b-II) Mn stearate, and
(b-VIII) Ca stearate;
   or
(a) polyolefin,
(b-I) the sodium salt of polyacrylic acid,
(b-II) Mn stearate,
(b-V) a sterically hindered amine light stabilizer, and
(b-VIII) Ca stearate.

B) An agricultural article as described above, made of

a composition containing
(a) a polyolefin,
(b-I) Na/Mn salt of polyacrylic acid,
   Mn salt of ethylene/acrylic acid copolymer,
   Fe salt of ethylene/acrylic acid copolymer,
   potassium salt of ethylene/acrylic acid copolymer,
   Mn/Fe salt of ethylene/acrylic acid copolymer,
   K/Mn salt of ethylene/acrylic acid copolymer,
   tridodecyl ammonium salt of ethylene/acrylic acid copolymer
   K/Mn salt of ethylene/methacrylic acid copolymer, or
   Fe/Mn salt of methyl methacrylate/methacrylic acid copolymer.

C) An agricultural article as defined above, made of

a composition containing
(a) a polyolefin,
(b-I) sodium salt of polyacrylic acid,
(b-I) Mn stearate, and
(b-VIII) Ca stearate;
   or
(a) a polyolefin,
(b-I) sodium salt of polyacrylic acid,
(b-I) Mn stearate, and
(b-VI) polyethyleneglycol.

A sodium salt of polyacrylic acid wherein nearly 100% of the —COOH groups of the polyacrylic acid are in the form of the sodium salt is preferred. This sodium salt has preferably a molecular weight of 2 000 to 6 000 g/mol, in particular 4 000 to 6 000 g/mol or 4 500 to 5 500 g/mol.

Examples of particularly preferred embodiments of the present invention relate to degradable mulch films with the following characteristics:

1) Transparent 10 to 25 micron monolayer or three-layer blown film containing:
(a) linear low density polyethylene,
(b-I) 0.1 to 1%, in particular 0.4%, of sodium polyacrylate with m=about 50, n=0 (preferred molecular weight: about 5 100 g/mol),
(b-II) 0.05 to 2%, in particular 0.14%, of manganese(II) stearate,
(b-III) 0.1 to 5%, in particular 0.4%, of calcium stearate,
(b-V) 0.05 to 2%, in particular 0.1%, of Tinuvin 783®¹⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite, and
(b-VII) 0.001 to 4%, in particular 0.02 to 2%, of octadecyl-3-(3,5-di-tert-butyl-4-hydroxyphenyl)propionate.
2) Transparent 10 to 25 micron monolayer or three-layer blown film containing:
(a) linear low density polyethylene,
(b-I) 0.1 to 1%, in particular 0.4%, of sodium polyacrylate with m=about 50, n=0 (preferred molecular weight: about 5 100 g/mol),
(b-II) 0.05 to 2%, in particular 0.14%, of manganese(II) stearate,
(b-III) 0.1 to 5%, in particular 0.4%, of calcium stearate,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite, and
(b-VII) 0.001 to 4%, in particular 0.02 to 2%, of octadecyl-3-(3,5-di-tert-butyl-4-hydroxyphenyl)propionate.
3) Non-transparent 10 to 25 micron monolayer or three-layer blown film:
(a) linear low density polyethylene,
(b-I) 0.1 to 1%, in particular 0.4%, of sodium polyacrylate with m=about 50, n=0 (preferred molecular weight: about 5 100 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of Tinuvin 783®¹⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
4) Non-transparent 10 to 25 micron monolayer or three-layer blown film:
(a) linear low density polyethylene,
(b-I) 0.1 to 1%, in particular 0.4%, of sodium polyacrylate with m=about 50, n=0 (preferred molecular weight: about 5 100 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of Chimassorb 944®²⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
5) Non-transparent 10 to 25 micron monolayer or three-layer blown film:
(a) linear low density polyethylene,
(b-I) 0.1 to 1%, in particular 0.4%, of sodium polyacrylate with m=about 50, n=0 (preferred molecular weight: about 5 100 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of a light stabilizer LS³⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
6) Non-transparent 10 to 25 micron monolayer or three-layer blown film:
(a) linear low density polyethylene,
(b-I) 0.1 to 1%, in particular 0.4%, of sodium polyacrylate with m=about 50, n=0 (preferred molecular weight: δ 100 g/mol),
(b-II) 0.05 to 2%, in particular 0.14%, of manganese(II) stearate,
(b-IV) 0.1 to 20%, in particular 0.1 to 10%, of carbon black,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
7) Transparent 10 to 25 micron monolayer or three-layer blown film containing:
(a) linear low density polyethylene,
(b-I) 0.1 to 5%, in particular 1.6%, of a sodium salt of ethylene/methacrylic acid copolymer (preferred molecular weight: about 200 000-500 000 g/mol),
(b-II) 0.05 to 2%, in particular 0.14%, of manganese(II) stearate,
(b-V) 0.05 to 2%, in particular 0.1%, of Tinuvin 783®¹⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite, and
(b-VII) 0.001 to 4%, in particular 0.02 to 2%, of octadecyl-3-(3,5-di-tert-butyl-4-hydroxyphenyl)propionate.
8) Transparent 10 to 25 micron monolayer or three-layer blown film containing:
(a) linear low density polyethylene,
(b-I) 0.1 to 5%, in particular 1.6%, of a sodium salt of ethylene/methacrylic acid copolymer (preferred molecular weight: about 200 000-500 000 g/mol),
(b-II) 0.05 to 2%, in particular 0.14%, of manganese(II) stearate,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite, and
(b-VII) 0.001 to 4%, in particular 0.02 to 2%, of octadecyl-3-(3,5-di-tert-butyl-4-hydroxyphenyl)propionate.
9) Non-transparent 10 to 25 micron monolayer or three-layer blown film:
(a) linear low density polyethylene,
(b-I) 0.1 to 5%, in particular 1.6%, of a sodium salt of ethylene/methacrylic acid copolymer (preferred molecular weight: about 200 000-500 000 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of Tinuvin 783®¹⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
10) Non-transparent 10 to 25 micron monolayer or three-layer blown film:
(a) linear low density polyethylene,
(b-I) 0.1 to 5%, in particular 1.6%, of a sodium salt of ethylene/methacrylic acid copolymer
(preferred molecular weight: about 200 000-500 000 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of Chimassorb 944®²⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
11) Non-transparent 10 to 25 micron monolayer or three-layer blown film:
(a) linear low density polyethylene,
(b-I) 0.1 to 5%, in particular 1.6%, of a sodium salt of ethylene/methacrylic acid copolymer (preferred molecular weight: about 200 000-500 000 g/mol),
(b-II) 0.05 to 2%, in particular 0.14%, of manganese(II) stearate,
(b-IV) 0.1 to 20%, in particular 0.1 to 10%, of carbon black,
(b-V) 0.1 to 2%, in particular 0.4 to 1%, of a light stabilizer LS³⁾,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.
12) Non-transparent 10 to 25 micron monolayer or three-layer blown film:
(a) linear low density polyethylene,
(b-I) 0.1 to 5%, in particular 1.6%, of a sodium salt of ethylene/methacrylic acid copolymer (preferred molecular weight: about 200 000-500 000 g/mol),
(b-II) 0.05 to 2%, in particular 0.14%, of manganese(II) stearate,
(b-IV) 0.1 to 20%, in particular 0.1 to 10%, of carbon black,
(b-VI-1) 0.00005 to 0.0005%, in particular 0.0001 to 0.0002%, of SiO₂,
(b-VI-2) 0.05 to 4%, in particular 0.1 to 0.5%, of tris(2,4-di-t-butylphenyl) phosphite,
(b-VII) 0.001 to 4%, in particular 0.02 to 2%, of octadecyl-3-(3,5-di-tert-butyl-4-hydroxyphenyl)propionate.

In the above listed preferred embodiments “%” means “% by weight, relative to the weight of the linear low density polyethylene (=component (a))”.

The carbon black is preferably added in the form of a masterbatch, e.g. PLASBLAK PE 2642 MB 40% LD®).

### ¹⁾Tinuvin® 783:

Mixture of poly[[6-[(1,1,3,3-tetramethylbutyl)amino]-1,3,5-triazine-2,4-diyl][(2,2,6,6-tetramethyl-4-piperidyl)imino]hexamethylene[(2,2,6,6-tetramethyl-4-piperidyl)imino]] and 1-(2-hydroxyethyl)-2,2,6,6-tetramethyl-4-hydroxypiperidine-succinic acid copolymer.

### ²⁾Chimassorb® 944:

Poly[[6-[(1,1,3,3-tetramethylbutyl)amino]-1,3,5-triazine-2,4-diyl][(2,2,6,6-tetramethyl-4-piperidyl)imino]hexamethylene[(2,2,6,6-tetramethyl-4-piperidyl)imino]].

### ³⁾Light Stabilizer LS:

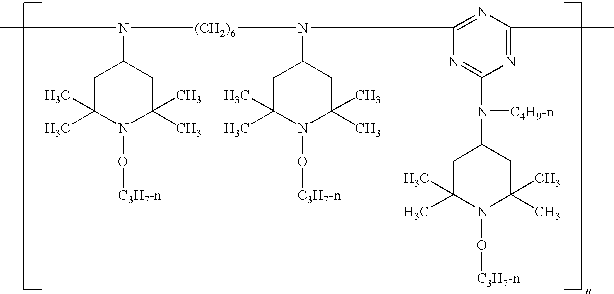

A further embodiment of the present invention relates to a method for controlling the weathering resistance and the degradation of an agricultural article made of an organic polymer, which method comprises incorporating into the organic polymer the components (b-I) and optionally (b-II) to (b-IX) as defined herein.

Several compounds of the formula (I) are novel. Thus, a further embodiment of the present invention relates to a compound of the formula (I-A)

—(X)ₘ—(Y)ₙ— (I-A)

wherein m is different from zero and n is zero or different from zero,
m+n is 10 to 10×10⁶, and when n is different from zero, the ratio of m/n is 1/100 to 100/1,
the recurring units X can have the same definition or different definitions,
the recurring units Y can have the same definition or different definitions and
the recurring units X and Y can have a random distribution or a block distribution;
X is a group of the formula (II-1) and Y is a group of the formula (II-2)

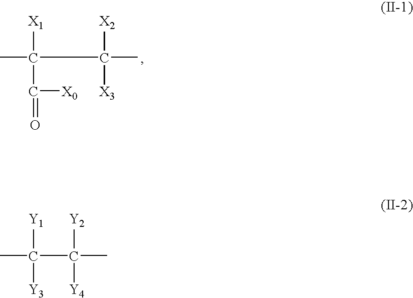

in which
X₁, X₂ and X₃ independently of one another are hydrogen, C₁-C₄alkyl or phenyl,
Y₁, Y₂ and Y₄ independently of one another are hydrogen, C₁-C₄alkyl or phenyl,
Y₃ is hydrogen, C₁-C₄alkyl, phenyl or a group —C(O)—Y₀,
X₀ is a group of the formula

—O⁻1/rM^{r+}, —O⁻N⁺(R₁)₄ or —N(R₃)₂,

Y₀ is a group of the formula

—OH or —O—R₂;

### M^{r+} is Mn²⁺, Mn³⁺, Mn⁴⁺, Fe²⁺, Fe³⁺, Co²⁺, Ca²⁺, Li⁺ or K⁺,

the radicals R₁ independently of one another are hydrogen, C₁-C₂₀alkyl, C₃-C₁₂cycloalkyl or phenyl,
R₂ is C₁-C₂₀alkyl or C₃-C₁₂cycloalkyl, and
the radicals R₃ independently of one another are hydrogen, C₁-C₂₀alkyl or C₃-C₁₂cycloalkyl;
with the provisos that
a) 1 to 100% of the recurring units X contain a metal and
b) that the compound of the formula (I) contains two different metals in an atomic ratio of 1:9 to 9:1; one metal being selected from the group consisting of Mn²⁺, Mn³⁺, Mn⁴⁺, Fe²⁺, Fe³⁺, Co²⁺, Ca²⁺, Li⁺ and K⁺, and the other metal being selected from the group consisting of Mn²⁺, Mn³⁺, Mn⁴⁺, Fe²⁺, Fe³⁺ and Co²⁺.

Examples of novel compounds containing transition metal ions which improve the degradability of an agricultural article are:
(IA-1) polyacrylic acid manganese/iron salt,
(IA-2) polyacrylic acid manganese/cobalt salt,
(IA-3) polyacrylic acid iron salt/cobalt salt,
(IA-4) polyacrylic acid lithium/manganese salt,
(IA-5) polyacrylic acid lithium/iron salt,
(IA-6) polyacrylic acid lithium/cobalt salt,
(IA-7) polyacrylic acid potassium/manganese salt,
(IA-8) polyacrylic acid potassium/iron salt,
(IA-9) polyacrylic acid potassium/cobalt salt,
(IA-10) polyacrylic acid calcium/manganese salt,
(IA-11) polyacrylic acid calcium/iron salt,
(IA-12) polyacrylic acid calcium/cobalt salt,
(IA-13) polymethacrylic acid manganese/iron salt,
(IA-14) polymethacrylic acid manganese/cobalt salt,
(IA-15) polymethacrylic acid iron salt/cobalt salt,
(IA-16) polymethacrylic acid lithium/manganese salt,
(IA-17) polymethacrylic acid lithium/iron salt,
(IA-18) polymethacrylic acid lithium/cobalt salt,
(IA-19) polymethacrylic acid potassium/manganese salt,
(IA-20) polymethacrylic acid potassium/iron salt,
(IA-21) polymethacrylic acid potassium/cobalt salt,
(IA-22) polymethacrylic acid calcium/manganese salt,
(IA-23) polymethacrylic acid calcium/iron salt,
(IA-24) polymethacrylic acid calcium/cobalt salt,
(IA-25) acrylic acid/methacrylic acid copolymer manganese/iron salt,
(IA-26) acrylic acid/methacrylic acid copolymer manganese/cobalt salt,
(IA-27) acrylic acid/methacrylic acid copolymer iron salt/cobalt salt,
(IA-28) acrylic acid/methacrylic acid copolymer lithium/manganese salt,
(IA-29) acrylic acid/methacrylic acid copolymer lithium/iron salt,
(IA-30) acrylic acid/methacrylic acid copolymer lithium/cobalt salt,
(IA-31) acrylic acid/methacrylic acid copolymer potassium/manganese salt,
(IA-32) acrylic acid/methacrylic acid copolymer potassium/iron salt,
(IA-33) acrylic acid/methacrylic acid copolymer potassium/cobalt salt,
(IA-34) acrylic acid/methacrylic acid copolymer calcium/manganese salt,
(IA-35) acrylic acid/methacrylic acid copolymer calcium/iron salt,
(IA-36) acrylic acid/methacrylic acid copolymer calcium/cobalt salt,
(IA-37) ethylene/acrylic acid copolymer manganese/iron salt,
(IA-38) ethylene/acrylic acid copolymer manganese/cobalt salt,
(IA-39) ethylene/acrylic acid copolymer iron salt/cobalt salt,
(IA-40) ethylene/acrylic acid copolymer lithium/manganese salt,
(IA-41) ethylene/acrylic acid copolymer lithium/iron salt,
(IA-42) ethylene/acrylic acid copolymer lithium/cobalt salt,
(IA-43) ethylene/acrylic acid copolymer potassium/manganese salt,
(IA-44) ethylene/acrylic acid copolymer potassium/iron salt,
(IA-45) ethylene/acrylic acid copolymer potassium/cobalt salt,
(IA-46) ethylene/acrylic acid copolymer calcium/manganese salt,
(IA-47) ethylene/acrylic acid copolymer calcium/iron salt,
(IA-48) ethylene/acrylic acid copolymer calcium/cobalt salt,
(IA-49) ethylene/methacrylic acid copolymer manganese/iron salt,
(IA-50) ethylene/methacrylic acid copolymer manganese/cobalt salt,
(IA-51) ethylene/methacrylic acid copolymer iron salt/cobalt salt,
(IA-52) ethylene/methacrylic acid copolymer lithium/manganese salt,
(IA-53) ethylene/methacrylic acid copolymer lithium/iron salt,
(IA-54) ethylene/methacrylic acid copolymer lithium/cobalt salt,
(IA-55) ethylene/methacrylic acid copolymer potassium/manganese salt,
(IA-56) ethylene/methacrylic acid copolymer potassium/iron salt,
(IA-57) ethylene/methacrylic acid copolymer potassium/cobalt salt,
(IA-58) ethylene/methacrylic acid copolymer calcium/manganese salt,
(IA-59) ethylene/methacrylic acid copolymer calcium/iron salt,
(IA-60) ethylene/methacrylic acid copolymer calcium/cobalt salt.

The examples below illustrate the invention in greater detail. All percentages and parts are by weight, unless stated otherwise.

### EXAMPLE 1

### Preparation of Ethylene/Acrylic Acid (5%) Copolymer Manganese Salt

A four-necked round-bottom flask equipped with a mechanical stirrer, thermocouple, dropping funnel and condenser is charged successively with 10.2 g of polyethylene-co-acrylic acid (5%) sodium salt (Aldrich® 426695) and 450 ml of tetrahydrofuran (THF). The mixture is heated up at reflux temperature and then a solution of 0.43 g of manganese chloride in 50 ml of THF is added. Subsequently, the reaction mixture is cooled and maintained at room temperature for 2 hours. Then, 200 ml of water are poured into the reaction mixture and the formed precipitate is recovered by filtering off the solution and is exsiccated at reduced pressure. 9.4 g of pink solid is obtained as the desired product.

Mn in % by weight: 1.98. m/n molar ratio: 2/98. Melting point: 98-107° C.

### EXAMPLE 2

### Preparation of Ethylene/Acrylic Acid (5%) Copolymer Iron Salt from Fe(II)

A four-necked round-bottom flask equipped with a mechanical stirrer, thermocouple, dropping funnel and condenser is charged successively with 81.0 g of polyethylene-co-acrylic acid (5%) sodium salt (Aldrich® 426733) and 3000 ml of tetrahydrofuran. The mixture is heated to reflux, and a solution of 7.7 g of FeSO₄×7H₂O in 50 ml of water is added. The reaction mixture is maintained at reflux temperature for 10 minutes. After cooling to room temperature, 200 ml of water are poured into the reaction mixture and the formed precipitate is isolated after filtration and washing with water and ethanol. After drying in vacuo, 75.5 g of the desired product is obtained as a pink-orange solid.

Fe in % by weight: 2.13. m/n molar ratio: 2/98. Melting point: 100-107° C.

### EXAMPLE 3

### Preparation of Ethylene/Acrylic Acid (5%) Copolymer Iron Salt from Fe(III)

A four-necked round-bottom flask equipped with a mechanical stirrer, thermocouple, dropping funnel and condenser is charged successively with 71.7 g of polyethylene-co-acrylic acid (5%) sodium salt (Aldrich® 426733) and 3000 ml of tetrahydrofuran. The mixture is heated to reflux, and a solution of 6.6 g of Fe(III) Cl₃×6H₂O in 40 ml of water is added. The reaction mixture is maintained at reflux temperature for 1 hour. After filtration, the precipitate is isolated after washing with water and ethanol. After drying in vacuo, 68.1 g of the desired product is obtained as an orange solid.

Fe in % by weight: 1.54. m/n molar ratio: 2/98. Melting point: 94-104° C.

### EXAMPLE 4

### Preparation of Ethylene/Acrylic Acid (20%) Copolymer Sodium/Manganese Salt

A four-necked round-bottom flask equipped with a mechanical stirrer, thermocouple, dropping funnel and condenser is charged successively with 25.0 g of polyethylene-co-acrylic acid (20%) (Aldrich® 181048; molecular weight: about 17 200 g/mol) and 500 ml of tetrahydrofuran. The mixture is heated to reflux, and a solution of 2.8 g of NaOH in 10 ml of water is added. Then, a solution of 4.4 g of manganese chloride in 50 ml of water is poured rapidly into the stirred mixture. The precipitate is isolated, after cooling to room temperature, by filtration and washing with water. After drying in vacuo, 25.6 g of the desired product is obtained as a pink solid.

Mn in % by weight: 3.46. Na in % by weight: 2.01. Mn/Na atomic ratio: 1.0/1.4. m/n molar ratio: 9/91. Softening temperature: 208° C.

### EXAMPLE 5

### Preparation of Ethylene/Acrylic Acid (20%) Copolymer Sodium/Iron Salt From Fe(II)

The compound is prepared as described in Example 2 by using polyethylene-co-acrylic acid (20%) (Aldrich® 181048; molecular weight: about 17 200 g/mol) as a starting material.

Fe in % by weight: 5.95. Na in % by weight: 1.56. Fe/Na atomic ratio: 1.0/0.6. m/n molar ratio: 9/91. Softening temperature: 115° C. Melting point: 216° C.

### EXAMPLE 6

### Preparation of Polyacrylic Acid Sodium/Manganese Salt

A four-necked round-bottom flask equipped with a mechanical stirrer, thermocouple, dropping funnel and condenser is charged successively with 100.0 g of polyacrylic acid sodium salt (molecular weight: about 5100 g/mol; Fluka® 81132) and 1000 ml of 1:1 ethanol/water. The mixture is heated to reflux. Then, a solution of 7.44 g of manganese chloride in 50 ml of water is poured rapidly into the mixture and the reaction is stirred for 48 hours at room temperature.

The viscous pink resin, recovered by decantation, is dried under vacuum and 76.9 g of the desired product is obtained as a white solid.

Mn in % by weight: 3.79. Na in % by weight: 18.4. Mn/Na atomic ratio: 1.0/11.7. Softening Temperature: 142° C.

### EXAMPLE 7

### Preparation of ethylene/acrylic acid (5%) copolymer tridodecyl ammonium salt.

A four-necked round-bottom flask equipped with a mechanical stirrer, thermocouple, dropping funnel and condenser is charged successively with 10.0 g of polyethylene-co-acrylic acid (5%) (Aldrich® 426717; molecular weight: less than 2000 g/mol) and 300 ml of tetrahydrofuran. The mixture is heated to reflux, and 3.6 g of tridocecylamine are added. The reaction mixture is maintained at reflux temperature for 10 minutes. After cooling to room temperature, 300 ml of water are poured into the reaction mixture and the formed precipitate is isolated after filtration and washing with ethanol. After drying in oven at 70° C. under reduced pressure, 12.5 g of the desired product are obtained as white solid.

m/n molar ratio: 2/98. Melting point: 94° C.

### EXAMPLE 8

### Preparation of ethylene/acrylic acid (5%) copolymer manganese/iron salt.

A four-necked round-bottom flask equipped with a mechanical stirrer, thermocouple, dropping funnel and condenser is charged successively with 30.0 g of polyethylene-co-acrylic acid (5%) (Aldrich® 426717; molecular weight: less than 2000 g/mol) and 1000 ml of tetrahydrofuran. The mixture is heated to reflux, and a solution of 0.83 g of NaOH in 10 ml of water is added. Thus, a solution of 1.1 g of Fe(III) Cl₃×6H₂O and 0.52 g of manganese chloride in 20 ml of water is poured into the reaction mixture maintained at reflux temperature and left to react for 30 minutes. After cooling to room temperature, 200 ml of water are poured into the reaction mixture and the formed precipitate is isolated after filtration and washing with water and ethanol. After drying in oven at 70° C. under reduced pressure, 29.9 g of the desired product are obtained as pink solid.

Mn in % by weight: 0.74. Fe in % by weight: 0.68. Mn/Fe atomic ratio: 1.0/0.9. m/n molar ratio: 2/98. Melting point: 95-103° C.

### EXAMPLE 9

### Preparation of Ethylene/Acrylic Acid (5%) Copolymer Potassium/Manganese Salt

A four-necked round-bottom flask equipped with a mechanical stirrer, thermocouple, dropping funnel and condenser is charged successively with 70.0 g of polyethylene-co-acrylic acid (5%) (Aldrich® 426717; molecular weight: less than 2000 g/mol) and 1000 ml of THF. The mixture is heated to reflux and a solution of 3.2 g of KOH in 10 ml of water is added to the solution. Then, a solution of 1.8 g of manganese chloride in 20 ml of water is poured rapidly into the mixture left under stirring for 10 minutes at reflux temperature. After cooling to room temperature, 300 ml of water are poured into the reaction mixture and the formed precipitate is isolated after filtration and washing with water and ethanol. After drying in oven at 70° C. under reduced pressure, 69.0 g of the desired product is obtained as off white solid.

Mn in % by weight: 1.06. K in % by weight: 1.38. Mn/K atomic ratio: 1.0/1.8. m/n molar ratio: 2/98. Melting point: 95-105° C.

### EXAMPLE 10

### Preparation of Ethylene/Acrylic Acid (5%) Copolymer Potassium Salt

A four-necked round-bottom flask equipped with a mechanical stirrer, thermocouple, dropping funnel and condenser is charged successively with 70.0 g of polyethylene-co-acrylic acid (5%) (Aldrich® 426717; molecular weight: less than 2000 g/mol) and 1000 ml of THF. The mixture is heated to reflux and a solution of 3.2 g of KOH in 10 ml of water is added to the solution. Then, the mixture is left under stirring for 10 minutes at reflux temperature. After cooling to room temperature, 300 ml of water are poured into the reaction mixture and the formed precipitate is isolated after filtration and washing with water and ethanol. After drying under reduced pressure, 66.5 g of the desired product is obtained as white solid.

K in % by weight: 2.77. m/n molar ratio: 2/98. Melting point: 96-104° C.

### EXAMPLE 11

### Preparation of Methylmethacrylate/Methacrylic Acid Copolymer Iron/Manganese Salt

A four-necked round-bottom flask equipped with a mechanical stirrer, thermocouple, dropping funnel and condenser is charged successively with 70.0 g of poly(methacrylic acid co-methyl methacrylate) (Fluka® 81359; molecular weight: about 35 000 g/mol) and 250 ml of THF. The mixture is heated to reflux and a solution of 2.0 g of NaOH in 10 ml of water is added to the solution and the mixture is left under stirring for 20 minutes at reflux temperature. Then, a solution of 2.7 g of Fe(III) Cl₃×6H₂O and 1.3 g of manganese chloride in 20 ml of water is poured into the mixture left to react under stirring at reflux temperature for 1 hour. Thus, 700 ml of water are poured into the reaction mixture and the formed gummy precipitate is separated from the crude solution at room temperature. After drying under reduced pressure, 69.9 g of the desired product is obtained as slight red solid.

Fe in % by weight: 0.76. Mn in % by weight: 0.75. Fe/Mn atomic ratio: 1.0/1.0. m/n molar ratio: 14/86. Melting point: 162-184° C.

### EXAMPLE 12

### Preparation of a Mixture of Polyacrylic Acid Sodium Salt/Calcium Stearate 1:1

A four-necked round-bottom flask equipped with a mechanical stirrer, thermocouple and condenser is charged successively with 40.0 g of polyacrylic acid sodium salt (molecular weight about 5100 g/mol; Fluka® 81132) and 40.0 g of calcium stearate. The mixture is heated to 180° C. and stirred for 7 hours. After cooling at room temperature the desired mixture is obtained as white solid.

Softening temperature: 159-179° C.

### EXAMPLE 13

### Preparation of a Mixture of Polyacrylic Acid Sodium Salt/Polyethylene Glycole (MW 3400) 1:1

A four-necked round-bottom flask equipped with a mechanical stirrer, thermocouple and condenser is charged successively with 40.0 g of polyacrylic acid sodium salt (molecular weight about 5100 g/mol; Fluka® 81132) and 40.0 g of polyethylene glycol (molecular weight 3400 g/mol) and 250 ml of water. The mixture is heated to reflux and stirred until a homogeneous solution is obtained. Then, the solution is concentrated under vacuum and essicated in oven under reduced pressure. The desired mixture is obtained as white solid.

Softening temperature: 58-65° C.

### EXAMPLE A

### Preparation of Linear Low Density Polyethylene (LLDPE) Monolayer Films

In a turbo mixer (Caccia®, Labo 10) the amount of each additive indicated in Table 1 is mixed with LLDPE Dowlex® NG 5056-G which contains 0.10% by weight of tris(2,4-di-t-butylphenyl) phosphite and 0.032% by weight of octadecyl-3-(3,5-di-tert-butyl-4-hydroxyphenyl)propionate and which has a melt index of 1.1 g/10 min (190° C./2.16 kg). The mixture is extruded to granules at a maximum temperature of 210° C. using either a COMAC® twin-screw extruder (0=32; L/D=34) or an O.M.C. twin-screw extruder (Ø=19; L/D=25). The granules are subsequently mixed and diluted with the same LLDPE in order to obtain the final composition for preparing a film 12 μm thick, using a blow-extruder (Dolci®) working at a maximum temperature of 210° C. Table 2 shows the final composition of the LLDPE films.

TABLE 1
Concentration of the master batch granules

| Additives | Extruder | Concentration |
|---|---|---|
| Manganese stearate | O.M.C. | 5% |
| Polyacrylic acid sodium salt | COMAC | 1% |
| (mol. weight about 5100 g/mol¹⁾) | | |

(“%” means “% by weight” relative to the LLDPE)
¹⁾Nearly 100% of the —COOH groups of the polyacrylic acid are in the form of the sodium salt.

TABLE 2
Final composition of the LLDPE films

| | Additives |
|---|---|
| Film 1 | None |
| Film 2 | 0.14% of Manganese stearate + 0.4% of |
| | Polyacrylic acid sodium salt |

(“%” means “% by weight” relative to the LLDPE)

### EXAMPLE B

### Preparation of LLDPE Mono Layer Films

In a turbo mixer (Caccia®, Labo 10) the amount of each additive indicated in Table 3 is mixed with LLDPE Dowlex® NG 5056-G which contains 0.10% by weight of tris(2,4-di-t-butylphenyl) phosphite and 0.032% by weight of octadecyl-3-(3,5-di-tert-butyl-4-hydroxyphenyl)propionate, and which has a melt index of 1.1 g/10 min (190° C./2.16 Kg). The mixture is extruded to granules at a maximum temperature of 210° C. using a COMAC® twin-screw extruder (Ø=32; L/D=34). The granules are subsequently mixed and diluted with the same LLDPE in order to obtain the final composition and converted to a mono layer film 12 pm thick, using a blow-extruder (Dolci®) working at a maximum temperature of 210° C. Table 4 illustrates the final composition of the LLDPE films.

TABLE 3
Concentration of the master batch granules

| Additives | Concentration |
|---|---|
| Manganese stearate | 5% |
| Polyacrylic acid sodium salt (from | 5% |
| Sigma-Aldrich (RTM), molecular weight | |
| ca. 5100 g/mol) | |

(“%” means “% by weight” relative to the LLDPE)

TABLE 4
Final composition of the LLDPE films

| | Additives |
|---|---|
| Film 3 | 0.14% of Manganese stearate + 0.4% of |
| | Polyacrylic acid sodium salt |

(“%” means “% by weight” relative to the LLDPE)

### EXAMPLE C

### Preparation of LLDPE Mono-Layer Films Containing Sterically Hindered Amine Compounds

The films are prepared in analogy to Example B.

TABLE 5
Concentration of the master batch granules

| Additives | Concentration |
|---|---|
| Manganese stearate | 5% |
| Polyacrylic acid sodium salt | 5% |
| (molecular weight ca. 5100 g/mol) | |
| Tinuvin (RTM) 783 | 10% |

(“%” means “% by weight” relative to the LLDPE)

Tinuvin® 783:

Mixture of poly[[6-[(1,1,3,3-tetramethylbutyl)amino]-1,3,5-triazine-2,4-diyl][(2,2,6,6-tetramethyl-4-piperidyl)imino]hexamethylene[(2,2,6,6-tetramethyl-4-piperidyl)imino]] and 1-(2-hydroxyethyl)-2,2,6,6-tetramethyl-4-hydroxypiperidine-succinic acid copolymer.

TABLE 6
Final composition of the LLDPE films

| | Additives |
|---|---|
| Film 4 | 0.14% of Manganese stearate + 0.4% of |
| | Polyacrylic acid sodium salt + |
| | 0.1% of Tinuvin (RTM) 783 |

(“%” means “% by weight” relative to the LLDPE)

### EXAMPLE D

### Preparation of LLDPE Mono Layer Films in Analogy to Example B

TABLE 7
Concentration of the master batch granules

| Additives | Concentration |
|---|---|
| Manganese stearate | 5% |

(“%” means “% by weight” relative to the LLDPE)

TABLE 8
Final composition of the LLDPE films

| | Additives |
|---|---|
| Film 5 | 0.14% of Manganese stearate + 1.6% of poly |
| | (ethylene-co-methacrylic acid) sodium salt*⁾ |
| | (MI 3.90 g/10 min. (190° C./2.16 Kg, ASTM D 1238)) |

(“%” means “% by weight” relative to the LLDPE)
*⁾The molecular weight of the poly (ethylene-co-methacrylic acid) sodium salt is about 200 000 to 500 000 g/mol and about 35 % of the —COOH groups of the poly (ethylene-co-methacrylic acid) are in the form of the sodium salt. About 10% of the copolymer are based on methacrylic acid monomers. A suitable poly (ethylene-co-methacrylic acid) sodium salt is for example available under No. 426695 from Sigma-Aldrich (RTM).

### EXAMPLE E

### Preparation of LLDPE Mono Layer Films

In a turbo mixer (Caccia®, Labo 10) the amount of each additive indicated in Table 9 is mixed with LLDPE Dowlex® NG 5056-G which contains 0.10% by weight of tris(2,4-di-t-butylphenyl) phosphite and 0.032% by weight of octadecyl-3-(3,5-di-tert-butyl-4-hydroxyphenyl)propionate, and which has a melt index of 1.1 g/10 min (190° C./2.16 Kg). The mixture is extruded to granules at a maximum temperature of 210° C. using an O.M.C.® twin-screw extruder (Ø=19; L/D=25). The granules are subsequently converted to a mono layer film 12 pm thick, using a blow-extruder (Formac®) working at a maximum temperature of 210° C. Table 9 illustrates the final composition of the LLDPE films.

TABLE 9
Final composition of the LLDPE films

| | Additives |
|---|---|
| Film 6 | None |
| Film 7 | 0.14% of Manganese stearate + 0.68% |
| | of the product of Example 7 |
| Film 8 | 0.69% of the product of Example 1 |
| Film 9 | 1.70% of the product of Example 8 |
| Film 10 | 1.30% of the product of Example 9 |
| Film 11 | 0.14% of Manganese stearate + 4.7% |
| | of the product of Example 10 |

(“%” means “% by weight” relative to the LLDPE)

### EXAMPLE F

### Oven Exposure

The films of Examples A to E are exposed in a static oven (Heraeus®, model 6120 UT) running at 50° C.

### Evaluation Parameters:

1) Carbonyl increment (CO): Evaluation of the carbonyl band increment (1710 cm−1) in function of the exposure time is monitored with a FT-IR Perkin-Elmer® Spectrum One.
2) Time to cracking: Visual failure of film samples is assessed according to time to the first evidence of surface cracking.

The results are shown in Tables 10 to 19.

TABLE 10
Carbonyl increment of 12 microns LLDPE
films in oven exposure at 50° C..

| Hours | Film 1 | Film 2 |
|---|---|---|
| 0 | 0.000 | 0.000 |
| 330 | 0.003 | — |
| 346 | — | 0.000 |
| 671 | 0.027 | — |
| 727 | — | 0.026 |
| 955 | 0.033 | |
| 1090 | — | 0.199 |
| 1354 | — | 0.326 |
| 1458 | 0.036 | — |
| 1588 | 0.036 | — |

These results clearly indicate that the additive mixture in Film 2 shows highest degree of oxidation (i.e. incorporation of oxygen).

TABLE 11
Time to cracking (in hours) of 12 microns LLDPE films
in oven exposure at 50° C..

| | Film 1 | Film 2 |
|---|---|---|
| Hours to cracking | >6755 | 1354 |

These results demonstrate that Film 2 containing the additive mixture shows the fastest degradation.

TABLE 12
Carbonyl increment of 12 microns LLDPE films
in oven exposure at 50° C..

| Hours | Film 1 | Film 3 | Film 4 |
|---|---|---|---|
| 0 | 0.000 | 0.000 | 0.000 |
| 330 | 0.003 | 0.001 | 0.000 |
| 646 | — | 0.019 | 0.012 |
| 671 | 0.027 | — | — |
| 955 | 0.033 | — | — |
| 1067 | — | 0.215 | 0.197 |
| 1258 | — | 0.317 | 0.316 |
| 1403 | | 0.392 | 0.366 |
| 1458 | 0.036 | — | — |
| 1588 | 0.036 | — | — |

These results clearly indicate that the additive mixture in Films 3 and 4 shows highest degree of oxidation (i.e. incorporation of oxygen).

TABLE 13
Time to cracking (in hours) of 12 microns LLDPE films
in oven exposure at 50° C..

| | Film 1 | Film 3 | Film 4 |
|---|---|---|---|
| Hours to cracking | >6755 | 1403 | 1594 |

These results demonstrate that Film 3 containing the additive mixture shows the fastest degradation and Film 4a reduced degradation rate compared to Film 3, but still considerably higher than Film 1.

TABLE 14
Carbonyl increment of 12 microns LLDPE films
in oven exposure at 50° C.

| Hours | Film 1 | Film 5 |
|---|---|---|
| 0 | 0.000 | 0.000 |
| 330 | 0.003 | — |
| 355 | — | 0.076 |
| 671 | 0.027 | — |
| 695 | 0.033 | 0.380 |

These results clearly indicate that the additive mixture in Film 5 shows highest degree of oxidation (i.e. incorporation of oxygen).

TABLE 15
Time to cracking (in hours) of 12 microns LLDPE films
in oven exposure at 50° C.

| | Film 1 | Film 5 |
|---|---|---|
| Hours to cracking | >6755 | 1149 |

These results demonstrate that Film 5 containing the additive mixture shows the fastest degradation.

TABLE 16
Carbonyl increment of 12 microns LLDPE films in
oven exposure at 50° C.

| Hours | Film 6 | Film 7 | Film 8 |
|---|---|---|---|
| 0 | 0.000 | 0.000 | 0.000 |
| 316 | 0.002 | 0.000 | 0.062 |
| 532 | 0.002 | 0.159 | 0.187 |
| 784 | 0.003 | 0.312 | 0.273 |
| 1119 | 0.000 | 0.442 | 0.391 |
| 1458 | 0.004 | 0.582 | 0.474 |
| 1775 | 0.004 | 0.668 | — |

These results clearly indicate that the additive mixture in Films 7 and 8 shows highest degree of oxidation (i.e. incorporation of oxygen).

TABLE 17
Time to cracking (in hours) of 12 microns LLDPE films
in oven exposure at 50° C.

| | Film 6 | Film 7 | Film 8 |
|---|---|---|---|
| Hours to cracking | >4095 | 1175 | 1175 |

These results demonstrate that Films 7 and 8 containing the additive mixture show the fastest degradation.

TABLE 18
Carbonyl increment of 12 microns LLDPE films in
oven exposure at 50° C.

| Hours | Film 6 | Film 9 | Film 10 | Film 11 |
|---|---|---|---|---|
| 0 | 0.000 | 0.000 | 0.000 | 0.000 |
| 312 | 0.000 | 0.040 | 0.061 | 0.000 |
| 665 | 0.000 | 0.288 | 0.290 | 0.177 |
| 888 | 0.000 | 0.387 | 0.415 | 0.311 |
| 1056 | 0.000 | 0.437 | 0.458 | 0.374 |

These results clearly indicate that the additive mixture in Films 9, 10 and 11 show highest degree of oxidation (i.e. incorporation of oxygen).

TABLE 19
Time to cracking (in hours) of 12 microns LLDPE films in
oven exposure at 50° C.

| | Film 6 | Film 9 | Film 10 | Film 11 |
|---|---|---|---|---|
| Hours to cracking | >1552 | 1423 | 1056 | 1056 |

These results demonstrate that Films 9, 10 and 11 containing the additive mixture show the fastest degradation.

### EXAMPLE G

### Light Exposure

The films of Examples A to E are exposed in an ATLAS Weatherometer (model Ci65A) equipped with a 6500 W Xenon lamp (continuous light cycle, black panel temperature=63° C.).

### Evaluation Parameters:

1) Carbonyl increment (CO): Evaluation of the carbonyl band increment (1710 cm−1) in function of the exposure time is monitored with a FT-IR Perkin-Elmer® Spectrum One.
2) Time to cracking: Visual failure of film samples is assessed according to time to the first evidence of surface cracking.

The results are shown from Tables 20 to Table 28.

TABLE 20
Carbonyl increment of 12 microns LLDPE films in Weatherometer.

| Hours | Film 1 | Film 2 |
|---|---|---|
| 0 | 0.000 | 0.000 |
| 170 | — | 0.011 |
| 326 | — | 0.035 |
| 557 | — | 0.071 |
| 718 | 0.093 | — |
| 881 | 0.130 | — |

These results clearly indicate that the additive mixture in Film 2 shows highest degree of oxidation (i.e. incorporation of oxygen).

TABLE 21
Time to cracking (in hours) of 12 microns
LLDPE films in Weatherometer.

| | Film 1 | Film 2 |
|---|---|---|
| Hours to cracking | 764 | 557 |

These results demonstrate that Film 2 containing the additive mixture shows the fastest degradation.

TABLE 22
Carbonyl increment of 12 microns LLDPE films in Weatherometer.

| Hours | Film 1 | Film 3 | Film 4 |
|---|---|---|---|
| 0 | 0.000 | 0.000 | 0.000 |
| 158 | 0.005 | 0.010 | 0.000 |
| 273 | 0.002 | 0.061 | 0.000 |
| 506 | 0.023 | 0.114 | 0.006 |
| 621 | 0.054 | — | 0.009 |
| 815 | 0.064 | — | 0.016 |
| 1001 | 0.111 | — | 0.033 |

These results clearly indicate that the additive mixture in Films 3 and 4 shows highest degree of oxidation (i.e. incorporation of oxygen).

TABLE 23
Time to cracking (in hours) of 12 microns LLDPE
films in Weatherometer.

| | Film 1 | Film 3 |
|---|---|---|
| Hours to cracking | 907 | 506 |

These results demonstrate that Film 3 containing the additive mixture shows the fastest degradation.

TABLE 24
Carbonyl increment of 12 microns LLDPE films in Weatherometer.

| Hours | Film 1 | Film 5 |
|---|---|---|
| 0 | 0.000 | 0.000 |
| 172 | 0.008 | 0.048 |
| 355 | 0.016 | 0.108 |

These results clearly indicate that the additive mixture in Film 5 shows highest degree of oxidation (i.e. incorporation of oxygen).

TABLE 25
Time to cracking (in hours) of 12 microns LLDPE
films in Weatherometer.

| | Film 1 | Film 5 |
|---|---|---|
| Hours to cracking | 1085 | 328 |

These results demonstrate that Film 5 containing the additive mixture shows the fastest degradation.

TABLE 26
Carbonyl increment of 12 microns LLDPE films in Weatherometer.

| Hours | Film 6 | Film 7 | Film 8 |
|---|---|---|---|
| 0 | 0.000 | 0.000 | 0.000 |
| 224 | 0.005 | 0.060 | 0.059 |
| 397 | 0.012 | 0.141 | 0.122 |

These results clearly indicate that the additive mixture in Films 7 and 8 shows highest degree of oxidation (i.e. incorporation of oxygen).

TABLE 27
Time to cracking (in hours) of 12 microns LLDPE
films in Weatherometer.

| | Film 6 | Film 7 | Film 8 |
|---|---|---|---|
| Hours to cracking | 738 | 397 | 397 |

These results demonstrate that Films 7 and 8 containing the additive mixture show the fastest degradation.

TABLE 28
Time to cracking (in hours) of 12 microns LLDPE
films in oven Weatherometer.

| | Film 6 | Film 9 | Film 10 | Film 11 |
|---|---|---|---|---|
| Hours to cracking | 936 | 274 | 445 | 274 |

These results demonstrate that Films 9, 10 and 11 containing the additive mixture show the fastest degradation.

1. An agricultural article made of a composition containing
(a) an organic polymer, and
(b-I) 0.001 to 9% by weight, relative to the weight of the organic polymer of one, two or more compounds of the formula (I)
—(X)ₘ—(Y)ₙ— (I)
wherein
m is different from zero,
n is zero or different from zero,
m+n is 10×10⁶, and
when n is different from zero, the ratio of m/n is 1/100 to 100/1,
the recurring units X can have the same definition or different definitions,
the recurring units Y can have the same definition or different definitions and
the recurring units X and Y can have a random distribution or a block distribution;
X is a group of the formula (II-1) and Y is a group of the formula (II-2) 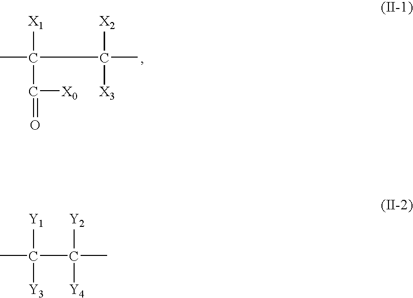
in which
X₁, X₂ and X₃ independently of one another are hydrogen, C₁-C₄alkyl or phenyl,
Y₁, Y₂ and Y₄ independently of one another are hydrogen, C₁-C₄alkyl or phenyl,
Y₃ is hydrogen, C₁-C₄alkyl, phenyl or a group —C(O)—Y₀,
X₀ is a group of the formula
—O⁻1/rM^{r+}, —O⁻N⁺(R₁)₄ or —N(R₃)₂,
and when n is zero, X₀ is additionally a group —OH or —OR₂,
Y₀ is a group of the formula
—OH or —O—R₂,
M is a metal cation of valency r with r being 1, 2, 3 or 4,
the radicals R₁ independently of one another are hydrogen, C₁-C₂₀alkyl, C₃-C₁₂cycloalkyl or phenyl,
R₂ is C₁-C₂₀alkyl or C₃-C₁₂cycloalkyl, and
the radicals R₃ independently of one another are hydrogen, C₁-C₂₀alkyl or C₃-C₁₂cycloalkyl; with the provisos that
1) component (b-I) is different from component (a);
2) when the compound of the formula (I) is either free of a transition metal cation or up to 1% of the recurring units X contain a transition metal cation, the composition contains as further component (b-II) one, two or more organic salts of a transition metal;
3) when in the compound of the formula (I) 1 to 100% of the recurring units X contain a transition metal cation, component (b-II) is optionally present in the composition;
4) component (b-II) is different from component (b-I); and
5) when, for n being different from zero, the metal cation of component (b-I) is selected from the group consisting of cations of Co, Cu, Mn or Cr, the composition contains either two or more different transition metal cations or as further component a pigment and/or a light stabilizer.

2. An agricultural article according to claim 1, wherein X₀ is a group of the formula
—O⁻1/r M^{r+}, —O⁻N⁺(R₁)₄ or —N(R₃)₂.

3. An agricultural article according to claim 1, wherein
one radical of the radicals X₁, X₂ and X₃ is different from hydrogen.

4. An agricultural article according to claim 1, wherein
Y₁, Y₂ and Y₄ independently of one another are hydrogen or C₁-C₄alkyl, and Y₃ is hydrogen, C₁-C₄alkyl, phenyl or —COOH.

5. An agricultural article according to claim 1, wherein
component (b-I) is a metal salt of polyacrylic acid,
C₁-C₄alkyl acrylate/acrylic acid copolymer,
polymethacrylate,
C₁-C₄alkyl methacrylate/methacrylic acid copolymer,
acrylic acid/methacrylic acid copolymer,
ethylene/acrylic acid copolymer,
ethylene/methacrylic acid copolymer,
ethylene/C₁-C₄alkyl acrylate/acrylic acid copolymer, or
ethylene/C₁-C₄alkyl methacrylate/methacrylic acid copolymer.

6. An agricultural article according to claim 1, wherein
the metal cation of component (b-I) is selected from the group consisting of alkali metal cations, earth alkali metal cations and transition metal cations.

7. An agricultural article according to claim 1, wherein
the metal cation of component (b-I) is selected from the group consisting of the cations of Li, Na, K, Ca, Mg, Mn, Fe, Co, Ni, Zn and Ce.

8. An agricultural article according to claim 1 wherein
the compound of the formula (I) contains two or more different metal cations.

9. An agricultural article according to claim 1 wherein
the compound of the formula (I) contains two different metal cations selected from the group consisting of the cations of Mn, Fe and Co.

10. An agricultural article according to claim 1 wherein
the compound of the formula (I) contains two different metal cations; one metal cation is Li⁺, Na⁺, K⁺, Ca²⁺_{1/2} or Zn²⁺_{1/2} and the other metal cation is selected from the group consisting of the cations of Mn, Fe and Co.

11. An agricultural article according to claim 1, wherein
component (b-I) is a polyacrylic acid sodium salt or a ethylene/acrylic acid copolymer manganese salt.

12. An agricultural article according to claim 1 containing components (b-I) and (b-II), wherein component (b-II) is a C₂-C₃₆carboxylate of Fe, Ce, Co, Mn or Ni.

13. An agricultural article according to claim 1 wherein
component (b-II) is
a C₁₂-C₂₀alkanoate of Mn or a C₁₂-C₂₀alkenoate of Mn.

14. An agricultural article according to claim 1 wherein
component (b-II) contains two different organic metal salts with different metal cations.

15. An agricultural article according to claim 1 wherein
component (b-I) is a polyacrylic acid sodium salt or an ethylene/methacrylic acid copolymer sodium salt, and
component (b-II) is manganese stearate.

16. An agricultural article according to claim 1, which contains in addition one or more of the following components
(b-III) a filler or reinforcing agent,
(b-IV) a pigment,
(b-V) a light stabilizer,
(b-VI) a processing additive,
(b-VII) an antioxidant,
(b-VIII) an inorganic or organic salt of Ca, Mg, Zn or Al, or an oxide of Ca, Mg, Zn or Al,
(b-IX) a terpene derivative.

17. An agricultural article according to claim 1 wherein
component (a) is a thermoplastic natural or synthetic polymer.

18. An agricultural article according to claim 1 wherein
component (a) is a polyolefin homo- or copolymer, a starch modified polyolefin or a starch based polymer composite.

19. An agricultural article according to claim 1 wherein
component (a) is polyethylene, polypropylene, a polyethylene copolymer or a polypropylene copolymer.

20. An agricultural article according to claim 1 which is selected from the group consisting of mulch films, small tunnel films, banana bags, direct covers, nonwoven, twines, clips, nettings, pipes, tubes and pots.

21. An agricultural article according to claim 1 which is a mulch film.

22. An agricultural article according to claim 1, made of a composition containing
(a) polyethylene
(b-I) the sodium salt of ethylene/methacrylic acid copolymer, and
(b-II) Mn stearate; or
(a) polyethylene,
(b-I) the sodium salt of ethylene/methacrylic acid copolymer,
(b-II) Mn stearate, and
(b-IV) carbon black; or
(a) polyethylene,
(b-I) the sodium salt of ethylene/methacrylic acid copolymer,
(b-II) Mn stearate, and
(b-V) a sterically hindered amine light stabilizer; or
(a) polyethylene,
(b-I) the sodium salt of ethylene/methacrylic acid copolymer,
(b-II) Mn stearate,
(b-IV) carbon black, and
(b-V) a sterically hindered amine light stabilizer; or
(a) a polyolefin,
(b-I) the sodium salt of polyacrylic acid, and
(b-II) Mn stearate; or
(a) polyolefin,
(b-I) the sodium salt of polyacrylic acid,
(b-II) Mn stearate, and
(b-VIII) Ca stearate; or
(a) polyolefin,
(b-I) the sodium salt of polyacrylic acid,
(b-II) Mn stearate,
(b-V) a sterically hindered amine light stabilizer, and
(b-VIII) Ca stearate.

23. An agricultural article according to claim 1, made of a composition containing
(a) a polyolefin and
(b-I) Na/Mn salt of polyacrylic acid,
Mn salt of ethylene/acrylic acid copolymer,
Fe salt of ethylene/acrylic acid copolymer,
potassium salt of ethylene/acrylic acid copolymer,
Mn/Fe salt of ethylene/acrylic acid copolymer,
K/Mn salt of ethylene/acrylic acid copolymer,
tridodecyl ammonium salt of ethylene/acrylic acid copolymer
K/Mn salt of ethylene/methacrylic acid copolymer, or
Fe/Mn salt of methyl methacrylate/methacrylic acid copolymer.

24. An agricultural article according to claim 1, made of a composition containing
(a) a polyolefin,
(b-I) sodium salt of polyacrylic acid,
(b-II) Mn stearate, and
(b-VIII) Ca stearate; or
(a) a polyolefin,
(b-I) sodium salt of polyacrylic acid,
(b-II) Mn stearate, and
(b-VI) polyethyleneglycol.

25. A method for controlling the weathering resistance and the degradation of an agricultural article made of an organic polymer, which method comprises incorporating into the organic polymer component (b-I) optionally in combination with component (b-II) as defined in claim 1 and subject to the provisos 1) to 5) of claim 1.

26. (canceled)

27. A compound of the formula (I-A)
—(x)ₘ—(Y)ₙ— (I-A)
wherein m is different from zero and n is zero or different from zero,
m+n is 10 to 10×10⁶, and when n is different from zero, the ratio of m/n is 1/100 to 100/1,
the recurring units X can have the same definition or different definitions,
the recurring units Y can have the same definition or different definitions and
the recurring units X and Y can have a random distribution or a block distribution;
X is a group of the formula (II-1) and Y is a group of the formula (II-2) 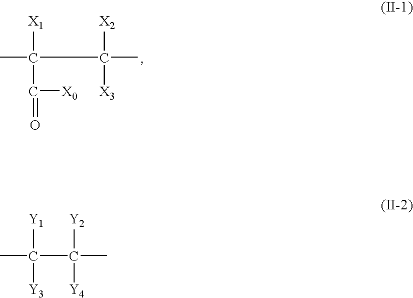
in which
X₁, X₂ and X₃ independently of one another are hydrogen, C₁-C₄alkyl or phenyl,
Y₁, Y₂ and Y₄ independently of one another are hydrogen, C₁-C₄alkyl or phenyl,
Y₃ is hydrogen, C₁-C₄alkyl, phenyl or a group —C(O)—Y₀,
X₀ is a group of the formula
—O⁻1/rM^{r+}, —O⁻N⁺(R₁)₄ or —N(R₃)₂,
Y₀ is a group of the formula
—OH or —O—R₂;
M^{r+} is Mn²⁺, Mn³⁺, Mn⁴⁺, Fe²⁺, Fe³⁺, Co²⁺, Ca²⁺, Li⁺ or K⁺,
the radicals R₁ independently of one another are hydrogen, C₁-C₂₀alkyl, C₃-C₁₂cycloalkyl or phenyl,
R₂ is C₁-C₂₀alkyl or C₃-C₁₂cycloalkyl, and
the radicals R₃ independently of one another are hydrogen, C₁-C₂₀alkyl or C₃-C₁₂cycloalkyl;
with the provisos that
a) 1 to 100% of the recurring units X contain a metal and
b) that the compound of the formula (I) contains two different metals in an atomic ratio of 1:9 to 9:1; one metal being selected from the group consisting of Mn²⁺, Mn³⁺, Mn⁴⁺, Fe²⁺, Fe³⁺, Co²⁺, Ca²⁺, Li⁺ and K⁺, and the other metal being selected from the group consisting of Mn²⁺, Mn³⁺, Mn⁴⁺, Fe²⁺, Fe³⁺ and Co²⁺.

28. A compound of the formula (I-A) according to claim 27, which is
polyacrylic acid manganese/iron salt,
polyacrylic acid manganese/cobalt salt,
polyacrylic acid iron salt/cobalt salt,
polyacrylic acid lithium/manganese salt,
polyacrylic acid lithium/iron salt,
polyacrylic acid lithium/cobalt salt,
polyacrylic acid potassium/manganese salt,
polyacrylic acid potassium/iron salt,
polyacrylic acid potassium/cobalt salt,
polyacrylic acid calcium/manganese salt,
polyacrylic acid calcium/iron salt,
polyacrylic acid calcium/cobalt salt,
polymethacrylic acid manganese/iron salt,
polymethacrylic acid manganese/cobalt salt,
polymethacrylic acid iron salt/cobalt salt,
polymethacrylic acid lithium/manganese salt,
polymethacrylic acid lithium/iron salt,
polymethacrylic acid lithium/cobalt salt,
polymethacrylic acid potassium/manganese salt,
polymethacrylic acid potassium/iron salt,
polymethacrylic acid potassium/cobalt salt,
polymethacrylic acid calcium/manganese salt,
polymethacrylic acid calcium/iron salt,
polymethacrylic acid calcium/cobalt salt,
acrylic acid/methacrylic acid copolymer manganese/iron salt,
acrylic acid/methacrylic acid copolymer manganese/cobalt salt,
acrylic acid/methacrylic acid copolymer iron salt/cobalt salt,
acrylic acid/methacrylic acid copolymer lithium/manganese salt,
acrylic acid/methacrylic acid copolymer lithium/iron salt,
acrylic acid/methacrylic acid copolymer lithium/cobalt salt,
acrylic acid/methacrylic acid copolymer potassium/manganese salt,
acrylic acid/methacrylic acid copolymer potassium/iron salt,
acrylic acid/methacrylic acid copolymer potassium/cobalt salt,
acrylic acid/methacrylic acid copolymer calcium/manganese salt,
acrylic acid/methacrylic acid copolymer calcium/iron salt,
acrylic acid/methacrylic acid copolymer calcium/cobalt salt,
ethylene/acrylic acid copolymer manganese/iron salt,
ethylene/acrylic acid copolymer manganese/cobalt salt,
ethylene/acrylic acid copolymer iron salt/cobalt salt,
ethylene/acrylic acid copolymer lithium/manganese salt,
ethylene/acrylic acid copolymer lithium/iron salt,
ethylene/acrylic acid copolymer lithium/cobalt salt,
ethylene/acrylic acid copolymer potassium/manganese salt,
ethylene/acrylic acid copolymer potassium/iron salt,
ethylene/acrylic acid copolymer potassium/cobalt salt,
ethylene/acrylic acid copolymer calcium/manganese salt,
ethylene/acrylic acid copolymer calcium/iron salt,
ethylene/acrylic acid copolymer calcium/cobalt salt,
ethylene/methacrylic acid copolymer manganese/iron salt,
ethylene/methacrylic acid copolymer manganese/cobalt salt,
ethylene/methacrylic acid copolymer iron salt/cobalt salt,
ethylene/methacrylic acid copolymer lithium/manganese salt,
ethylene/methacrylic acid copolymer lithium/iron salt,
ethylene/methacrylic acid copolymer lithium/cobalt salt,
ethylene/methacrylic acid copolymer potassium/manganese salt,
ethylene/methacrylic acid copolymer potassium/iron salt,
ethylene/methacrylic acid copolymer potassium/cobalt salt,
ethylene/methacrylic acid copolymer calcium/manganese salt,
ethylene/methacrylic acid copolymer calcium/iron salt, or
ethylene/methacrylic acid copolymer calcium/cobalt salt.

29. A masterbatch containing
(a) an organic polymer,
(b) 10 to 70%, relative to the weight of the organic polymer, of an additive mixture containing
(b-I) a compound of the formula (I) as defined in claim 1 and
(b-II) C₂-C₃₆carboxylate of Fe, Ce, Co, Mn or Ni;
for the preparation of an agricultural article as defined in claim 1.

30. A masterbatch containing
(a) a linear low density polyethylene,
(b) 3 to 60% by weight, relative to the weight of the linear low density polyethylene, of an additive mixture containing
(b-I) a sodium salt of polyacrylic acid or a sodium salt of ethylene/methacrylic acid copolymer and
(b-II) manganese stearate.

31. A masterbatch according to claim 30, containing
(a) a linear low density polyethylene,
(b-I) 2 to 10% by weight, relative to the weight of the linear low density polyethylene, of a sodium salt of a polyacrylic acid,
(b-II) 1 to 5% by weight, relative to the weight of the linear low density polyethylene, of manganese stearate and
(b-III) 2 to 10% by weight, relative to the weight of the linear low density polyethylene, of calcium stearate.

32. A masterbatch according to claim 30, containing
(a) a linear low density polyethylene,
(b-I) 30 to 50% by weight, relative to the weight of the linear low density polyethylene, of a sodium salt of ethylene/methacrylic acid copolymer and
(b-II) 1 to 5% by weight, relative to the weight of the linear low density polyethylene, of manganese stearate.
